(19) United States
(12) Patent Application Publication
(10) Pub. No.: US 2007/0048485 A1
(43) Pub. Date: Mar. 1, 2007

(54) Magnetoresistive effect element, magnetic head, magnetic storage device and magnetic memory device

(75) Inventors: Arata Jogo, Kawasaki (JP); Hirotaka Oshima, Kawasaki (JP); Keiichi Nagasaka, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/437,757

(22) Filed: May 22, 2006

(30) Foreign Application Priority Data
Aug. 25, 2005 (JP) 2005-244507
Mar. 28, 2006 (JP) 2006-087433

(51) Int. Cl. B32B 3/02

(52) U.S. Cl. 428/64.1

(57) ABSTRACT

A magnetoresistive effect element of a CPP type includes a fixed magnetization layer, a non-magnetic layer and a free magnetization layer formed of CoFeAl. The CoFeAl has a composition falling within a range defined by straight lines connecting points A, B, C, D, E, F and A, in that order, in a ternary composition diagram. The point A is (55, 10, 35), the point B is (50, 15, 35), the point C is (50, 20, 30), the point D is (55, 25, 20), the point E is (60, 25, 15), and the point F is (70, 15, 15), where coordinates of the composition of each point is represented by (Co content, Fe content, Al content). Each content is expressed by atomic percent.

### BACKGROUND OF THE INVENTION

1. Field of the Invention

The present invention relates to magnetoresistive effect elements for reproducing information in magnetic storage device and, more particularly, to a magnetoresistive effect element having a structure of a CPP (Current-Perpendicular-to-Plane) in which a sense current flows in a direction of lamination of a film stack constituting the magnetoresistive effect element.

2. Description of the Related Art

In recent years, a magnetoresistive effect element is used for a magnetic head of a magnetic storage, as a reproducing element for reproducing information recorded on a magnetic recording medium. The magnetoresistive effect element reproduces information recorded on a magnetic-recording medium using a magnetoresistive effect, which converts a change in a direction of a signal magnetic field leaking from a magnetic recording medium into a change in electric resistance.

With progress in high recording density of a magnetic storage device, a magnetic head having a spin valve film has become popular. The spin valve film has a stacked structure of a fixed magnetic layer of which magnetization is fixed in a predetermined direction, a non-magnetic layer, and a free magnetization layer of which direction of magnetization changes in response to a direction or an intensity of a magnetic field leaking from a magnetic recording medium. The spin valve film has an electric resistance value which changes in accordance with an angle formed by magnetization of the fixed magnetization layer and magnetization of the free magnetization layer. By detecting a voltage change by causing a sense current of a constant value to flow through the spin valve film, a magnetoresistive effect element reproduces bits recorded on a magnetic recording medium.

Conventionally, a CIP (Current-In-Plane) structure in which a sense current is caused to flow in an in-plane direction of a spin valve film has been used for magnetoresistive effect elements. However, in order to attempt higher recording density, it is required to increase a linear recording density and a track density of a magnetic recording medium. In a magnetoresistive effect element, it is necessary to reduce a thickness of the element corresponding to a bit length and a width of the element corresponding to a track width of a magnetic recording medium, that is, a cross-sectional area of the element. In such a case of reducing the element thickness, if the CIP structure is used, a current density of the sense current is large, that may cause degradation in a performance due to migration in materials forming a spin valve film.

Thus, the CPP (Current-Perpendicular-to-Plane) type structure is suggested where a sense current is caused to flow in a stacking direction of the spin valve film, that is, a direction of stacking a fixed magnetization layer, a non-magnetic layer and a free magnetization layer, and are studied as a reproducing element of a next generation. The spin valve film of the CPP type has a feature in that an output hardly changes even if a core width (a width of the spin valve film corresponding to a track width of a magnetic recording medium) is reduced in a condition of a constant current density of the sense current, and, therefore, it is suitable for achieving high-density recording.

An output of the CPP type spin valve film is determined by an amount of change in a magnetic resistance of a unit area when an external magnetic field is applied to a spin valve film by sweeping from one direction to an opposite direction. The amount of change in a magnetic resistance of a unit area is equal to a product of an amount of change in a magnetic resistance of the spin valve film and an area of a film surface of the spin valve film. In order to increase the amount of change in a magnetic resistance of a unit area, simply speaking, it is necessary to use a material having a large product of a spin-dependent bulk scattering coefficient and a specific resistance for the free magnetization layer and the fixed magnetization layer. The spin-dependent bulk scattering is a phenomenon in which a degree of scattering of conduction electrons differs between two directions of spin of the conduction electrons in the free magnetization layer or the fixed magnetization layer. The amount of change in a magnetic resistance increases as the spin-dependent bulk scattering coefficient increases.

As a material having a large spin-dependent bulk scattering coefficient, there is suggested, in Japanese Laid-Open Patent Applications No. 2004-221526 and No. 2005-019484, a magnetoresistive effect element using a Co₂FeₓCr₁₋ₓAl (0≦x≦1) material or a Co₂FeAl material as a material having a large spin-dependent bulk scattering coefficient,

However, if Co₂FeₓCr₁₋ₓAl containing a large amount of Cr is used for a free magnetization layer or a fixed magnetization layer, a spin-dependent bulk scattering coefficient is decreased, thereby reducing an amount of change in magnetic resistance. As a result, an output of the magnetoresistive effect element is decreased.

Moreover, if Co₂FeAl, which has a composition of a Heusler alloy (atomic concentration of Co, Fe and Al is 50 atomic %, 25 atomic % and 25 atomic %, respectively), is used for a free magnetization layer, a sensitivity of a magnetoresistive element is decreased since a coercive force is large and a response of magnetization of the free magnetization layer to a signal magnetic field from a magnetic recording medium is slow. Generally, the signal magnetic field intensity from a magnetic recording medium tends to decrease as high density recording progresses. Thus, a substantial amount of change in magnetic resistance is decreased, which results in reduction of an output of a magnetoresistive element. Additionally, if a coercive force is too large, magnetization of a free magnetization layer by a signal magnetic field hardly rotates, which may result in that an output is hardly obtained.

### SUMMARY OF THE INVENTION

It is a general object of the present invention to provide an improved and useful magnetoresistive element in which the above-mentioned problems are eliminated.

A more specific object of the present invention is to provide a magnetoresistive element having a high output and also having a good sensitivity in detection of a magnetic field, and a magnetic head and a magnetic storage device having such a magnetoresistive element.

In order to achieve the above-mentioned invention, there is provided according to one aspect of the present invention a magnetoresistive effect element of a CPP type, comprising: a fixed magnetization layer; a non-magnetic layer; and a free magnetization layer formed of CoFeAl, wherein the CoFeAl has a composition falling within a range defined by straight lines connecting points A, B, C, D, E, F and A, in that order, in a ternary composition diagram where the point A is (55, 10, 35), the point B is (50, 15, 35), the point C is (50, 20, 30), the point D is (55, 25, 20), the point E is (60, 25, 15), and the point F is (70, 15, 15), where coordinates of the composition of each point is represented by (Co content, Fe content, Al content), where each content is expressed by atomic percent.

The CoFeAl has a spin-dependent bulk scattering coefficient almost equal to that of the CoFe and relatively larger than that of other soft magnetic materials. Additionally, the CoFeAl has a specific resistance about six times the specific resistance of CoFe. Accordingly, by using CoFeAl for the free magnetization layer or the fixed magnetization layer, an amount of change in magnetic resistance, which depends on a product of a spin-dependent bulk scattering coefficient and a specific resistance, is extremely larger than that of CoFe. As a result, the output of the magnetoresistive effect element can be extremely increased. Thus, the magnetoresistive effect element according to the present invention has a large amount of change in magnetic resistance due to CoFeAl used for the free magnetization layer, which permits a high output of the magnetoresistive effect element.

Further, according to the study of the inventors, it was found that by setting the composition of CoFeAl of the free magnetization layer within the range ABCDEFA, the coercive force of the free magnetization layer is reduced, which realizes the magnetoresistive effect element having a good sensitivity to a signal magnetic field.

Additionally, there is provided according to another aspect of the present invention a magnetic head comprising: a substrate forming a base of a head slider; and the above-mentioned magnetoresistive effect element. Since the magnetoresistive effect element has a high output and a good sensitivity to a signal magnetic field, the magnetic head can perform magnetic recording with higher recording density.

Further, there is provided according to another aspect of the present invention a magnetic storage device comprising: a magnetic recording medium; and a magnetic head reading information recorded on the magnetic recording medium, the magnetic head including the above-mentioned magnetoresistive effect element. Since the magnetoresistive effect element has a high output and a good sensitivity to a signal magnetic field, the magnetic storage device can achieve high-density recording.

Additionally, there is provided according to another aspect of the present invention a magnetic memory device comprising: a magnetoresistive effect film of a CPP type having a fixed magnetization layer, a non-magnetic layer, and a free magnetization layer; writing means for orienting a magnetization of the free magnetization layer to a predetermined direction by applying a magnetic field to the magnetoresistive effect film; and reading means for detecting a resistance value by supplying a sense current to the magnetoresistive effect film, wherein the free magnetization layer is made of CoFeAl, and the CoFeAl has a composition falling within a range defined by straight lines connecting points A, B, C, D, E, F and A, in that order, in a ternary composition diagram where the point A is (55, 10, 35), the point B is (50, 15, 35), the point C is (50, 20, 30), the point D is (55, 25, 20), the point E is (60, 25, 15), and the point F is (70, 15, 15), where coordinates of the composition of each point is represented by (Co content, Fe content, Al content), where each content is expressed by atomic percent.

According to the above-mentioned invention, an amount of change in magnetic resistance ΔRA is large since CoFeAl is used for the free magnetization layer, and a difference between magnetic resistance values corresponding to “0” and “1” retained is large when reading information, thereby enabling accurate reading. Additionally, by setting the composition of the CoFeAl of the free magnetization layer to be a composition within the above-mentioned range ABCDEFA, a coercive force of the free magnetization layer is reduced, which can reduce power consumption.

Other objects, features and advantages of the present invention will become more apparent from the following detailed description when read in conjunction with the accompanying drawings.

### BRIEF DESCRIPTION OF THE DRAWINGS

FIG. 1 is an illustration showing a part of a compound type magnetic head having a magnetoresistive effect element according to a first embodiment of the present invention;

FIG. 2 is a cross-sectional view of a GMR film of a first example which constitutes a magnetoresistive effect element according to the first embodiment of the present invention;

FIG. 3 is a cross-sectional view of a GMR film of a second example which constitutes the magnetoresistive effect element according to the first embodiment of the present invention;

FIG. 4 is a cross-sectional view of a GMR film of a third example which constitutes the magnetoresistive effect element according to the first embodiment of the present invention;

FIG. 5 is a cross-sectional view of a GMR film of a fourth example which constitutes the magnetoresistive effect element according to the first embodiment of the present invention;

FIG. 6 is a cross-sectional view of a GMR film of a fifth example which constitutes the magnetoresistive effect element according to the first embodiment of the present invention;

FIG. 7 is an illustration showing compositions of a free magnetization layer and lower and upper second fixed magnetization layers, a coercive force and an amount of change in magnetic resistance ΔRA in a practical example 1;

FIG. 8 is a ternary composition diagram of Co, Fe and Al showing a composition range of a free magnetization layer;

FIG. 9 is an illustration showing compositions of a lower second fixed magnetization layer and an upper second fixed magnetization layer;

FIG. 10 is a graph showing a relationship between ΔRA and a specific resistance and a spin-dependent bulk scattering coefficient of a free magnetization layer;

FIG. 11 is a cross-sectional view of a TMR film of a first example which constitutes a magnetoresistive effect element according to a second embodiment of the present invention;

FIG. 12 is a cross-sectional view of a TMR film of a second example which constitutes a magnetoresistive effect element according to the second embodiment of the present invention;

FIG. 13 is a cross-sectional view of a TMR film of a third example which constitutes a magnetoresistive effect element according to the second embodiment of the present invention;

FIG. 14 is a cross-sectional view of a TMR film of a fourth example which constitutes a magnetoresistive effect element according to the second embodiment of the present invention;

FIG. 15 is a cross-sectional view of a TMR film of a fifth example which constitutes a magnetoresistive effect element according to the second embodiment of the present invention;

FIG. 16 is a plane view of a magnetic storage device according to a third embodiment of the present invention;

FIG. 17A is a cross-sectional view of a magnetic memory device of a first example according to a fourth embodiment of the present invention;

FIG. 17B is a schematic diagram showing a configuration of a GMR film shown in FIG. 17A according to the fourth embodiment of the present invention;

FIG. 18 is an equivalent circuit diagram of a memory cell of the magnetic memory device of the first example according to the fourth embodiment of the present invention;

FIG. 19 is a diagram showing a configuration of a TMR film forming a variation of the magnetic memory device of the first example according to the fourth embodiment of the present invention; and

FIG. 20 is a cross-sectional view of a magnetic memory device of a second example according to the fourth embodiment of the present invention.

### DETAILED DESCRIPTION OF THE PREFERRED EMBODIMENTS

A description will now be given, with reference to the drawings, of embodiments according to the present invention. Unless otherwise specifically noted, an amount of change in magnetic resistance of a unit area ΔRA is referred to as an amount of change in electric resistance ΔRA or simply referred to as ΔRA.

### First Embodiment

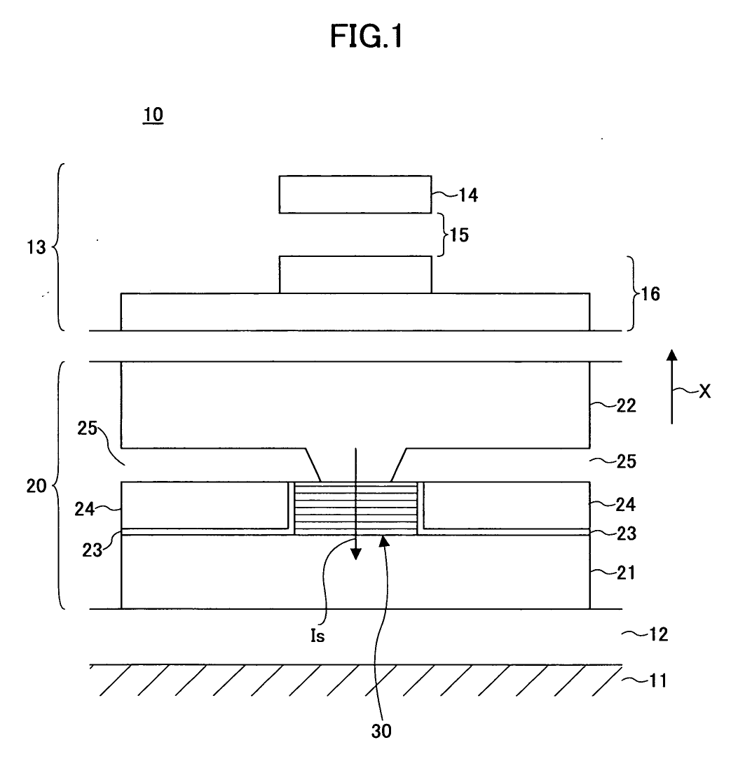

A description will now be given of a compound type magnetic head having a magnetoresistive effect element according to a first embodiment of the present invention and an induction type recording element. FIG. 1 is an illustration showing a part the compound type magnetic head. In FIG. 1, an arrow X indicates a direction of movement of a magnetic recording medium facing the magnetoresistive effect element.

With reference to FIG. 1, the compound type magnetic head 10 comprises a flat ceramic substrate 11 formed of Al₂O₃—TiC and serving as a head slider, the magnetoresistive effect element 20 formed on the ceramic substrate 11, and the induction type recording element 13 formed on the magnetoresistive effect element 20.

The induction type recording element 13 comprises: an upper magnetic pole 14 facing a magnetic recording medium and having a width corresponding to a track width of the magnetic recording medium; a recording gap layer 15; a lower magnetic pole 16 opposite to the upper magnetic pole with the recording gap layer 15 interposed therebetween; a yoke (not shown in the figure) magnetically connecting the upper magnetic pole 14 and the lower magnetic pole 16 with each other; and a coil (not shown in the figure) surrounding the yoke to induce a recording magnetic field by a recording current flowing through the coil. Each of the upper magnetic pole 14, the lower magnetic pole 16 and the yoke is formed of a soft magnetic material. As for the soft magnetic material, there are materials having a large saturation magnetic flux density so as to acquire a desired recording magnetic field, such as, for example, Ni₈₀Fe, CoZrNb, FeN, FeSiN, FeCo, CoNiFe, etc. It should be noted that the induction type recording element 13 is not limited to the above-mentioned structure, and an induction type recording element having a known structure may be used.

The magnetoresistive effect element 20 comprises a lower electrode 21, a magnetoresistive film 30 (hereinafter referred to as GMR film 30), an alumina film 25 and an upper electrode 22 that are stacked in that order on an alumina film 12 formed on a surface of the ceramic substrate 11. The GMR film 30 is electrically connected to each of the lower electrode 21 and the upper electrode 22.

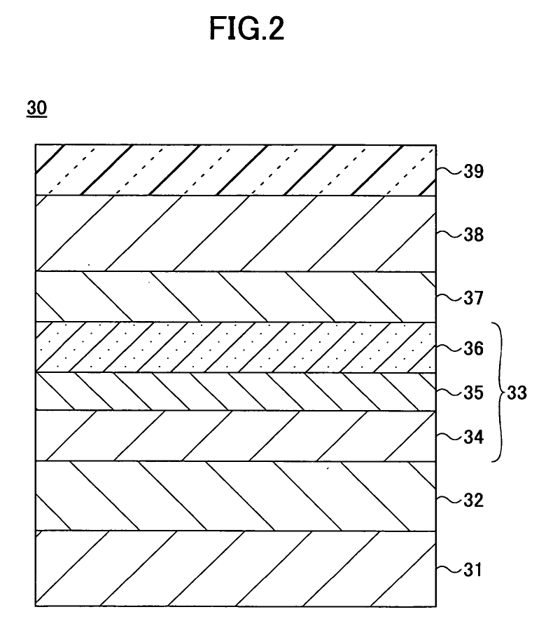

A magnetic-domain control film 24 is formed on each side of the GMR film 30 via an insulating film 23. The magnetic-domain control film 24 is a layered product of a Cr film and a CoCrPt film. The magnetic-domain control film 24 causes a free magnetization layer (shown in FIG. 2) constituting the GMR film 30 to be single magnetic-domain so as to prevent from generating Barkhausen noise.

In addition to serving as a passage of a sense current Is, the lower electrode 21 and the upper electrode 22 serve also as a magnetic shield. Therefore, each of the lower electrode 21 and the upper electrode 22 is formed of a soft magnetic material such as, for example, NiFe, CoFe, CoZrNb, FeN, FeSiN, CoNiFe, etc. Furthermore, an electrically conductive film, such as, for example, a Cu film, a Ta film, a Ti film, etc., may be provided to an interface surface between the lower electrode 21 and the GMR film 30.

Moreover, the magnetoresistive effect element 20 and the induction type recording element 13 are covered by an alumina film, a carbon hydride film or the like so as to prevent corrosion, etc.

The sense current Is flows through the GMR film 30, for example, from the upper electrode 22, in a substantially vertical direction and reaches the lower electrode 21. The GMR film 30 changes in its electric resistance value, that is, a so-called magnetic resistance value, in response to intensity and a direction of a signal magnetic field leaking from the magnetic recording medium. The magnetoresistive effect element 20 detects a change in the magnetic resistance value of the GMR film 30 by causing the sense current Is of a predetermined amount of current. As mentioned above, the magnetoresistive effect element 20 reproduces information recorded on the magnetic recording medium. It should be noted that the direction of the flow of the sense current Is is not limited to the direction shown in FIG. 1, and it may be a reversed direction. Additionally, the moving direction of the magnetic recording medium may be reversed.

FIG. 2 is a cross-sectional view of the GMR film of a first example which constitutes the magnetoresistive effect element according to the first embodiment of the present invention.

With reference to FIG. 2, the GMR film 30 of the first example has a so-called single spin valve structure in which a foundation layer 31, an antiferromagnetic layer 32, a fixed magnetization layered product 33, a non-magnetic metal layer 37, a free magnetic layer 38 and a protection layer 39 are stacked sequentially in that order.

The foundation layer 31 is formed on a surface of the lower electrode 21 shown in FIG. 1 by a sputter method or the like. The foundation layer 31 consists of a layered product of, for example, a NiCr film or a Ta film (for example, a film thickness of 5 nm) and a NiFe film (for example, a film thickness of 5 nm). The NiFe film preferably contains Fe in a range from 17 atomic % to 25 atomic %. Using the NiFe film of such a composition, the antiferromagnetic layer 32 epitaxially grows on the (111) crystal plane, which is a direction of crystal growth of the NiFe film, and a crystal plane crystallographically equivalent to the (111) crystal plane. Thereby, the crystallinity of the antiferromagnetic layer 32 is improved.

The antiferromagnetic layer 32 is formed of, for example, a Mn-TM alloy (TM includes at least one of Pt, Pd, Ni, Ir and Rh) having a film thickness of 4 nm to 30 nm. As for the Mn-TM alloy, there are, for example, PtMn, PdMn, NiMn, IrMn and PtPdMn. The antiferromagnetic layer 32 fixes the magnetization of the first fixed magnetization layer 34 in a predetermined direction by exerting an exchange interaction on the first fixed magnetization layer 34 of the fixed magnetization layered product 33.

The fixed magnetization layered product 33 has a so-called layered ferromagnetic structure in which the first fixed magnetization layer 34, a non-magnetic coupling layer 35 and a second fixed magnetization layer 36 are stacked in that order from the side of the antiferromagnetic layer 32. In the fixed magnetization layered product 33, the magnetization of the first fixed magnetization layer 34 and the magnetization of the second fixed magnetization layer 36 are exchange-coupled in antiferromagnetic manner, and the directions of magnetization are opposite to each other.

Each of the first and second fixed magnetization layers 34 and 36 is formed of a ferromagnetic material containing at least one of Co, Ni and Fe having a film thickness of 1 to 30 nm. As a suitable ferromagnetic material for the first and second fixed magnetization layers 34 and 36, there are, for example, CoFe, CoFeB, CoFeAl, NiFe, FeCoCu, CoNiFe, etc. It should be noted that each of the first and second fixed magnetization layers 34 and 36 can be not only a single layer but also a layered product of two or more layers. The layered product may use a material of a combination of layers of the same element but different composition ratio. Alternatively, a material of a combination of different elements may be used.

The second fixed magnetization layer 36 is preferably formed of CoFeAl. This is for the following reasons. The spin-dependent bulk scattering coefficient of CoFeAl is of the same degree as the spin-dependent bulk scattering coefficient of CoFe, which is a soft magnetic material, and is relatively larger than spin-dependent bulk scattering coefficients of other soft magnetic materials. For example, the spin-dependent bulk scattering coefficient of Co₉₀Fe₁₀ is 0.55, while the spin-dependent bulk scattering coefficient of Co₅₀Fe₂₀Al₃₀ is 0.50. Additionally, the specific resistance of CoFeAl is extremely larger than CoFe. For example, the specific resistance of Co₉₀Fe₁₀ is 20 μΩcm, while the specific resistance of Co₅₀Fe₂₀Al₃₀ is 130 μΩcm, which is about 6 times. Since an amount of change in magnetic resistance depends on a product of a spin-dependent bulk scattering coefficient and a specific resistance, the amount of change in magnetic resistance ΔRA of CoFeAl is extremely larger than that of CoFe. Therefore, the amount of change in magnetic resistance ΔRA can be greatly increased by using CoFeAl for the second fixed magnetization layer 36.

Furthermore, since the spin-dependent bulk scattering coefficient and the specific resistance of CoFeAl have the small dependability on the composition ratio of CoFeAl, there is an advantage in that a control of composition of CoFeAl at the time of manufacturing becomes easy. It should be noted that CoFeAl is also suitable for the free magnetization layer 38 for the advantages mentioned above.

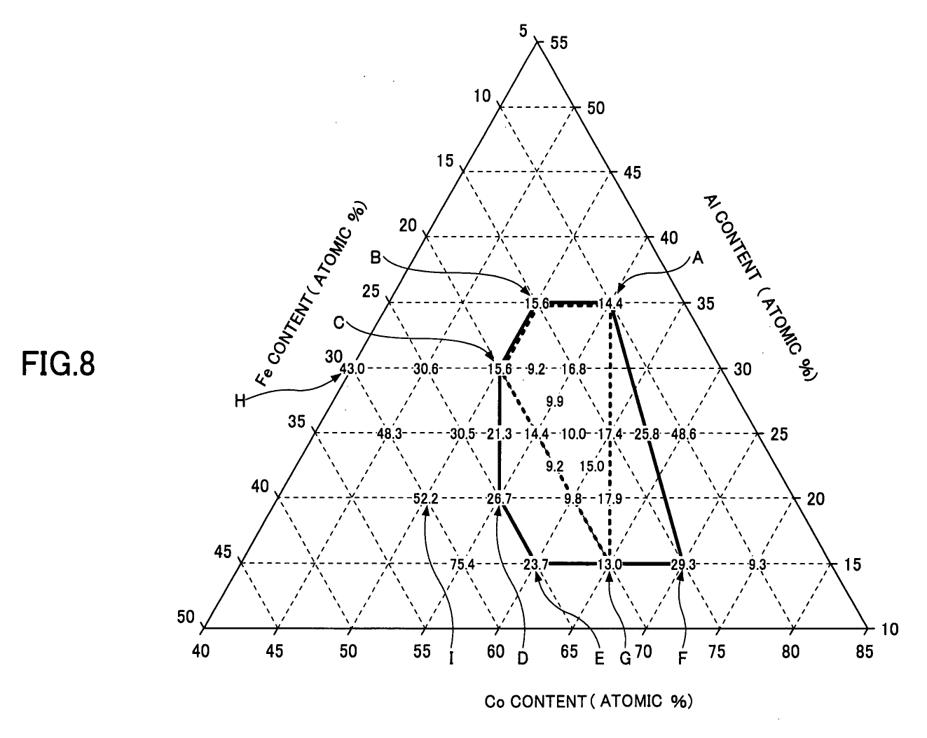

In the second fixed magnetization layer 36, in consideration of a large amount of change in magnetic resistance ΔRA, CoFeAl preferably has a composition within an area CHIDC in a ternary composition diagram shown in FIG. 8 as explained in a second embodiment mentioned later. The area CHIDC is defined as an area surrounded by straight lines connecting a point C (50, 20, 30), a point H (40, 30, 30), a point I (50, 30, 20), a point D (55, 25, 20) and the point C (50, 20, 30), in that order, where coordinates of each composition is expressed by (Co content, Fe content, Al content). It should be noted that the content of each of Co, Fe and Al is expressed by atomic %. Additionally, a coercive force of the second fixed magnetization layer 36 is not limited to a specific value since it does not give influence to the signal magnetic field of the magnetoresistive effect element.

Moreover, as a soft material suitable for the first fixed magnetization layer 34, there are Co₆₀Fe₄₀ and NiFe in consideration of a low specific resistance. Since the magnetization of the first fixed magnetization layer 34 is in a direction opposite to the direction of magnetization of the second fixed magnetization layer 36, the first fixed magnetization layer 34 acts to reduce the amount of change in magnetic resistance ΔRA. In such a case, a reduction in the amount of change in magnetic resistance ΔRA can be suppressed by using a ferromagnetic material having a low resistance.

A thickness of the non-magnetic coupling layer 35 is set to a value within a range in which the first fixed magnetization layer 34 and the second fixed magnetization layer 36 are exchange-coupled in antiferromagnetic manner. The range is 0.4 nm to 1.5 nm (preferably 0.4 nm to 0.9 nm). The non-magnetic coupling layer 35 is formed of a non-magnetic material such as Ru, Rh, Ir, a Ru-based alloy, a Rh-based alloy, a Ir-based alloy, etc. As the Ru-based alloy, a non-magnetic material of any one of Co, Cr, Fe, Ni and Mn, or an alloy of the aforementioned may be used.

Furthermore, although illustration is omitted, a ferromagnetic joining layer, which has a higher saturation magnetic-flux density than that of the first fixed magnetization layer 34, may be provided between the first fixed magnetization layer 34 and the antiferromagnetic layer 32. Thereby, the exchange interaction between the first fixed magnetization layer 34 and the antiferromagnetic layer 32 can be increased, which eliminates a problem in that a direction of the magnetization of the first fixed magnetization layer 34 is changed or reversed from a predetermined direction.

The non-magnetic metal layer 37 is formed of an electrically conductive, non-magnetic material having a film thickness of, for example, 1.5 nm to 10 nm. As an electrically conductive material suitable for the non-magnetic metal layer 37, there are Cu, Al, etc.

The free magnetization layer 38 is provided on a surface of the non-magnetic metal layer 37, and is formed of CoFeAl having a film thickness of, for example, 2 nm to 12 nm. As mentioned above, the spin-dependent bulk scattering coefficient of CoFeAl is of the same degree as the spin-dependent bulk scattering coefficient of CoFe and the specific resistance of CoFeAl is extremely larger than the specific resistance of CoFe. Thus, an amount of change in magnetic resistance ΔRA of the free magnetization layer 38 is extremely larger than that of the case where CoFe is used.

Furthermore, the magnetization of the free magnetization layer 38 preferably has a good response to an externally applied signal magnetic field. Thus, it is better to set the coercive force of the free magnetization layer 38 as small as possible, and CoFeAl constituting the free magnetization layer 38 has a composition range acquired by a first example mentioned later. The composition range is defined by an area ABCDEFA in a ternary composite diagram of CoFeAl shown in FIG. 8 mentioned later. The area ABCDEFA is defined by straight lines connecting a point A (55, 10, 35), a point B (50, 15, 35), a point C (50, 20, 30), a point D (55, 25, 20), a point E (60, 25, 15), a point F (70, 15, 15) and the point A (55, 10, 35) in that order, where the coordinates of each composition is expressed by (Co content, Fe content, Al content). The composition range has an amount of change in magnetic resistance ΔRA equivalent to Co₅₀Fe₂₅Al₂₅, which is a composition of a Heusler alloy, and a coercive force thereof is reduced. Therefore, the magnetoresistive effect element can provide a high output while sensitivity to a signal magnetic field can be raised.

Furthermore, the coercive force of the free magnetization layer 38 can be set equal to or lower than 20 Oe by setting the composition range of the free magnetization layer 38 to a range ABCGA in the ternary composition diagram of CoFeAl shown in FIG. 8 mentioned later. The range ABCGA is defined by straight lines connecting a point A (55, 10, 35), a point B (50, 15, 35), a point C (50, 20, 30), a point G (65, 20, 15) and the point A (55, 10, 35) in that order, where the coordinates of each composition is expressed by (Co content, Fe content, Al content). Thereby, sensitivity to a signal magnetic field can be raised further.

The protection layer 39 is formed of a non-magnetic, electrically conductive material such as, for example, a metal film containing one of Ru, Cu, Ta, Au, Al and W, and may be formed of a layered product of the aforementioned metal films. The protection layer 39 can prevent oxidation of the free magnetization layer 38 when performing a heat treatment to cause an appearance of the antiferromagnetism of the antiferromagnetic layer 32 explained below.

A description will be given, with reference to FIG. 2, of a method of forming the GMR film 30 of the first example. First, each of the layers from the foundation layer 31 to the protection layer 39 is formed by a sputter method, a vapor deposition method, a CVD method or the like using the above-mentioned materials.

Subsequently, the thus-obtained layered product is heat-treated in a magnetic field. The heat treatment is performed in a vacuum atmosphere and, for example, at a heating temperature of 250° C. to 320° C., a heating time of about 2 to 4 hours and the magnetic field of 1592 kA/m. According to the heat treatment, a part of the above-mentioned Mn-TM alloy turns to a regularization alloy, thereby providing antiferromagnetism. Moreover, the direction of magnetization of the antiferromagnetic layer 32 is set in a parallel to a predetermined direction by applying a magnetic field in a predetermined direction when performing the heat treatment so that the magnetization of the fixed magnetization layer 33 is in a predetermined direction due to an exchange interaction between the antiferromagnetic layer 32 and the fixed magnetization layer 33.

Subsequently, the layered product from the foundation layer 31 to the protection layer 39 is patterned in a predetermined shape as shown in FIG. 1 so as to obtain the GMR film 30. It should be noted that GMR films of second through fifth example explained below are formed in the same manner as the GMR film 30 of the first example.

Since the free magnetization layer 38 is formed of CoFeAl, the GMR film 30 of the first example has a large amount of change in magnetic resistance ΔRA. Further, since CoFeAl of the free magnetization layer 38 is set within the above-mentioned predetermined composition range, the coercive force of the free magnetization layer 38 is low. Thus, the magnetoresistive effect element having a high output and a good sensitivity to a signal magnetic field can be achieved.

A description will now be given of the GMR film of a second example which constitutes the magnetoresistive effect element according to the first embodiment of the present invention. The GMR film of the second example is applied to the GMR film 30 of the magnetoresistive effect element 10 shown in FIG. 1.

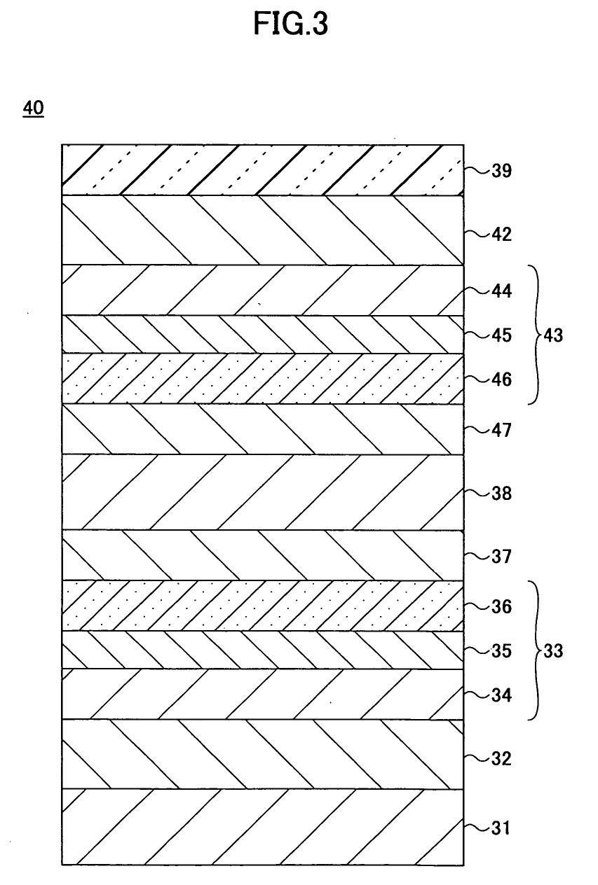

FIG. 3 is a cross-sectional view of the GMR film of the second example, which constitutes the magnetoresistive effect element according to the first embodiment of the present invention. In FIG. 3, parts that are the same as the parts explained before are given the same reference numerals, and descriptions thereof will be omitted.

With reference to FIG. 3, the GMR film 40 of the second example has a structure in which the foundation layer 31, a lower antiferromagnetism layer 32, a lower fixed magnetization layered product 33, a lower non-magnetic metal layer 37, the free magnetization layer 38, an upper non-magnetic metal layer 47, an upper fixed magnetization layered product 43, an upper antiferromagnetic layer 42, and the protection layer 39 are stacked sequentially in that order. That is, the GMR film 40 has a so-called dual spin valve structure in which the upper non-magnetic metal layer 47, the upper fixed magnetization layered product 43, and the upper antiferromagnetic layer 42 are provided between the free magnetization layer 38 and the protection layer 39 of the GMR film of the first example shown in FIG. 2. It should be noted that the lower antiferromagnetic layer 32, the lower fixed magnetization layered product 33, and the lower non-magnetic metal layer 34 are formed by the same material and have the same film thickness as the antiferromagnetic layer 32, the fixed magnetization layer 33 and the non-magnetic metal layer 34 of the GMR film of the first example shown in FIG. 2, respectively, and the same reference numerals are used.

The upper non-magnetic metal layer 47 and the upper antiferromagnetic layer 42 can be formed of the same material as the lower non-magnetic metal layer 37 and the lower antiferromagnetic layer 32, respectively, and the film thickness is set in the same range.

Moreover, the upper fixed magnetization layered product has a so-called layered ferrimagnetic structure in which the upper first fixed magnetization layer 44, the upper non-magnetic joining layer 45 and the second fixed magnetization layer 46 are stacked sequentially in that order on the side of the upper antiferromagnetic layer 42. The upper first fixed magnetization layer 44, the upper non-magnetic joining layer 45 and the second fixed magnetization layer 46 can be formed by the same materials as the lower first fixed magnetization layer 34, the lower non-magnetic joining layer 35 and the lower second fixed magnetization layer 36, respectively, and the film thickness is set in the same range.

The free magnetization layer 38 of the GMR film 40 is selected from the same composition range of CoFeAl as the free magnetization layer 38 of the GMR film of the first example shown in FIG. 2. Accordingly, the magnetoresistive effect element has a large amount of change in magnetic resistance ΔRA for the same reason as the case of the GMR film of the first example, and the coercive force is reduced. Therefore, a high output can be obtained while sensitivity to a signal magnetic field is increased.

Furthermore, the GMR film 40 has both the spin valve structure formed by the lower fixed magnetization layered product 33, the lower non-magnetic metal layer 37 and the free magnetization layer 38 and the spin valve structure formed by the free magnetization layer 38, the upper non-magnetic metal layer 47 and the upper fixed magnetization layered product 43. Therefore, an amount of change in magnetic resistance ΔRA of the GMR film 40 is increased, and reaches about twice the amount of change in magnetic resistance of the GMR film of the first example. As a result, by using the GMR film 40 in the magnetoresistive effect element, the magnetoresistive effect element can provide a higher output than that of the case where the GMR film of the first example is used. It should be noted that a method of forming the GMR film 40 is the same as the method of forming the GMR film of the first example, and a description thereof will be omitted.

A description will now be given of a GMR film of a third example which constitutes the magnetoresistive effect element according to first embodiment of the present invention. The GMR film of the third example is applied to the GMR film 30 of the magnetoresistive effect element 10 shown in FIG. 1.

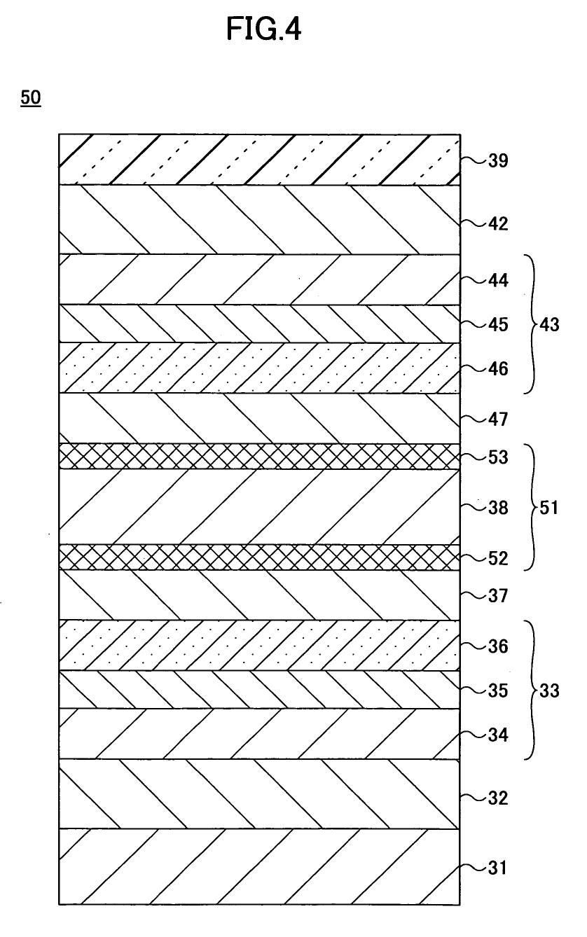

FIG. 4 is a cross-sectional view of the GMR film of the third example which constitutes the magnetoresistive effect element according to the first embodiment of the present invention. The GMR film of the third example is a variation of the GMR film of the second example. In FIG. 4, parts that are the same as the parts explained before are given the same reference numerals, and descriptions thereof will be omitted.

With reference to FIG. 4, the GMR film 50 of the third example has a structure in which the foundation layer 31, the lower antiferromagnetic layer 32, the lower fixed magnetization layered product 33, the lower non-magnetic metal layer 37, a free magnetization layered product 51, the upper non-magnetic metal layer 47, the upper fixed magnetization layered product 43, the upper antiferromagnetic layer 42, and the protection layer 39 are stacked sequentially in that order. That is, the GMR film 50 has the structure in which the free magnetization layered product 51 is provided in stead of the free magnetization layer 38 of the GMR film 30 of the first example shown in FIG. 2.

The free magnetization layered product 51 is formed by a first interface magnetic layer 52, the free magnetization layer 38 and a second interface magnetic layer 53 that are stacked sequentially in that order. The free magnetization layer 38 is formed of CoFeAl of the same composition range as the free magnetization layer 38 of the GMR film 30 of the second example shown in FIG. 2.

The thickness of each of the first interface magnetic layer 52 and the second interface magnetic layer 53 is set in the range of, for example, 0.2 nm to 2.5 nm, and is formed of a soft magnetic material. Each of the first interface magnetic layer 52 and the second interface magnetic layer 53 is preferably formed of a material having a spin-dependent interface scattering coefficient larger than that of the CoFeAl, such as, for example, CoFe, a CoFe alloy, NiFe and a NiFe alloy. As the CoFe alloy, there are, for example, CoFeNi, CoFeCu, CoFeCr, etc. Additionally, as the NiFe alloy, there are NiFeCu, NiFeCr, etc. The amount of change in magnetic resistance ΔRA of the free magnetization layered product can be increased by sandwiching the free magnetization layer 38 between the soft magnetic material films having a large spin-dependent interface scattering coefficient. It should be noted that materials of the same composition may be used for the first interface magnetic layer 52 and the second interface magnetic layer 53, or materials containing the same elements and have different composition ratios may be used or materials having different elements to each other may be used.

Furthermore, CoFeAl of a different composition ratio from the free magnetization layer 38 may be used for the first interface magnetic layer 52 and the second interface magnetic layer 53. For example, a material having a coercive force higher than that of the free magnetization layer 38 may be used for the first interface magnetic layer 52 and the second interface magnetic layer 53.

The GMR film 50 of the third example has the same effect as the GMR film of the second example, and an amount of change in magnetic resistance ΔRA can be increased to be higher than that of the GMR film of the second example by providing the first interface magnetic layer 52 and the second interface magnetic layer 53 to both sides of the free magnetization layer 38.

A description will now be given of a GMR film of a fourth example which constitutes the magnetoresistive effect element according to the first embodiment of the present invention. The GMR film of the fourth example is applied to the GMR film 30 of the magnetoresistive effect element 10 shown in FIG. 1.

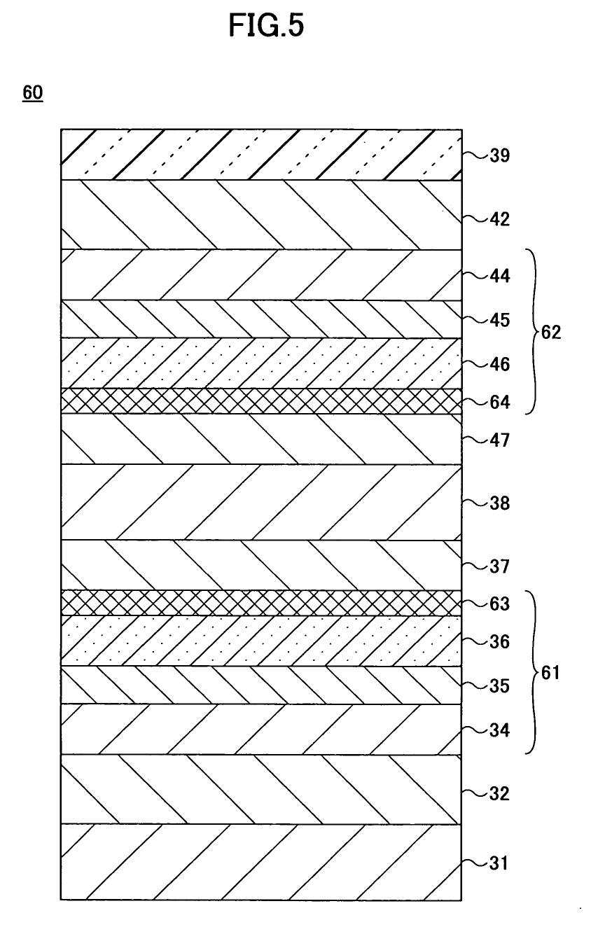

FIG. 5 is a cross-sectional view of the GMR film of the fourth example which constitutes the magnetoresistive effect element according to the first embodiment of the present invention. The GMR film of the fourth example is a variation of the GMR film of the second example. In FIG. 5, parts that are the same as the parts explained before are given the same reference numerals, and descriptions thereof will be omitted.

With reference to FIG. 5, the GMR film 60 of the fourth example has a structure in which the foundation layer 31, the lower antiferromagnetic layer 32, a lower fixed magnetization layered product 61, the lower non-magnetic metal layer 37, the free magnetization layer 38, the upper non-magnetic metal layer 47, an upper fixed magnetization layered product 62, the upper antiferromagnetic layer 42, and the protection layer 39 are stacked sequentially in that order. That is, the GMR film 60 has the structure in which the lower fixed magnetization layered product 61 and the upper fixed magnetization layered product 62 are provided instead of the lower fixed magnetization layered product 33 and the upper fixed magnetization layered product 43 of the GMR film 40 of the second example shown in the FIG. 3.

The lower magnetization layered product 61 includes a third interface magnetic layer 63 provided to the lower second magnetization layer 36 on the side of the lower non-magnetic metal layer 37. On the other hand, the upper magnetization layered product 62 includes a fourth interface magnetic layer 64 provided to the upper second magnetization layer 46 on the side of the upper non-magnetic metal layer 47. The thickness of each of the third interface magnetic layer 63 and the fourth interface magnetic layer 64 is set in the range of, for example, 0.2 nm to 2.5 nm, and is formed of a ferromagnetic material. Each of the third interface magnetic layer 63 and the fourth interface magnetic layer 64 is preferably formed of a material having a spin-dependent interface scattering coefficient larger than that of the CoFeAl, such as, for example, CoFe, a CoFe alloy, NiFe and a NiFe alloy. As the CoFe alloy, there are, for example, CoFeNi, CoFeCu, CoFeCr, etc. Additionally, as the NiFe alloy, there are NiFeCu, NiFeCr, etc. The amount of change in magnetic resistance ΔRA can be increased. It should be noted that materials of the same composition may be used for the third interface magnetic layer 63 and the fourth interface magnetic layer 64, or materials containing the same elements and have different composition ratios may be used or materials having different elements to each other may be used.

The GMR film 60 of the fourth example has the same effect as the GMR film of the second example, and an amount of change in magnetic resistance ΔRA can be increased to be higher than that of the GMR film of the second example by providing the third interface magnetic layer 63 and the fourth interface magnetic layer 64.

A description will now be given of the GMR film of a fifth example which constitutes the magnetoresistive effect element according to the first embodiment of the present invention. The GMR film of the fifth example is applied to the GMR film 30 of the magnetoresistive effect element 10 shown in the FIG. 1.

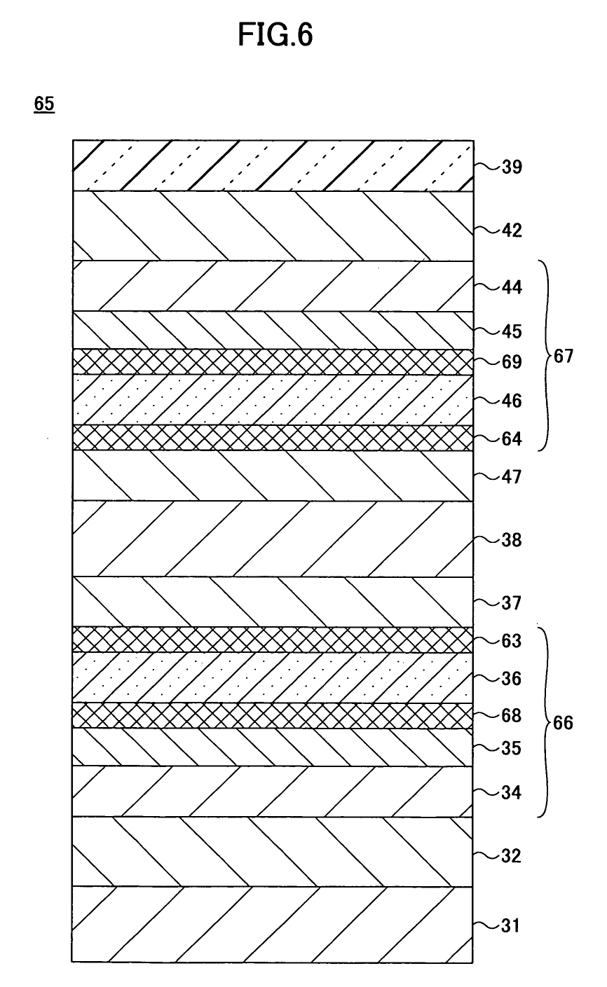

FIG. 6 is a cross-sectional view of the GMR film of the fifth example which constitutes the magnetoresistive effect element according to the first embodiment of the present invention. The GMR film of the fifth example is a variation of the GMR film of the fourth example. In FIG. 6, parts that are the same as the parts explained before are given the same reference numerals, and descriptions thereof will be omitted.

With reference to FIG. 6, the GMR film 65 of the fifth example has a structure in which the foundation layer 31, the lower antiferromagnetic layer 32, a lower fixed magnetization layered product 66, the lower non-magnetic metal layer 37, the free magnetization layer 38, the upper non-magnetic metal layer 47, an upper fixed magnetization layered product 67, the upper antiferromagnetic layer 42, and the protection layer 39 are stacked sequentially in that order. The GMR film 65 of the fifth example has the same structure as the GMR film of the fourth example except that the lower fixed magnetization layered product 66 includes a first ferromagnetic joining layer 68 provided to the lower second fixed magnetization layer 36 on the side of the lower non-magnetic joining layer 35 and the upper fixed magnetization layered product 67 includes a second ferromagnetic joining layer 69 provided to the upper second fixed magnetization layer 46 on the side of the upper non-magnetic joining layer 45.

The thickness of each of the first ferromagnetic joining layer 68 and the second ferromagnetic joining layer 69 is set in a range, for example, from 0.2 nm to 2.5 nm, and each of the first ferromagnetic joining layer 68 and the second ferromagnetic joining layer 69 is formed of a ferromagnetic material containing al least one of Co, Ni and Fe, such as, for example, CoFe, CoFeB or CoNiFe. Each of the first ferromagnetic joining layer 68 and the second ferromagnetic joining layer 69 is capable of increasing the exchange-coupling with the lower first fixed magnetization layer 34 and the upper first fixed magnetization layer 44 by using a ferromagnetic material having a saturation magnetization larger than that of the lower second fixed magnetization layer 36 and the upper second fixed magnetization layer 46, respectively, thereby further stabilizing the direction of magnetization on the lower second fixed magnetization layer 36 and the upper second fixed magnetization layer 46. As a result, an amount of change in magnetic resistance ΔRA can be stabilized.

As explained above, the GMR film 65 of the fifth example has the same effect as the GMR film of the example of the second example, and an amount of change in magnetic resistance ΔRA can be stabilized by providing the first ferromagnetic joining layer 68 and the second ferromagnetic joining layer 69.

It should be noted that although the GMR films of the third through fifth examples are variations of the dual spin valve GMR film of the second example in the first embodiment, variations the same as the GMR films of the third through fifth examples may be applied to the free magnetic layer or the second fixed magnetic layer of the single spin valve GMR film shown in FIG. 2. Additionally, the GMR film of the third example and the GMR film of the fourth or fifth embodiment may be combined with each other.

### PRACTICAL EXAMPLE 1

In the practical example 1, the magnetoresistive effect element having the structure of the GMR film of the second example shown in FIG. 3 was fabricated.

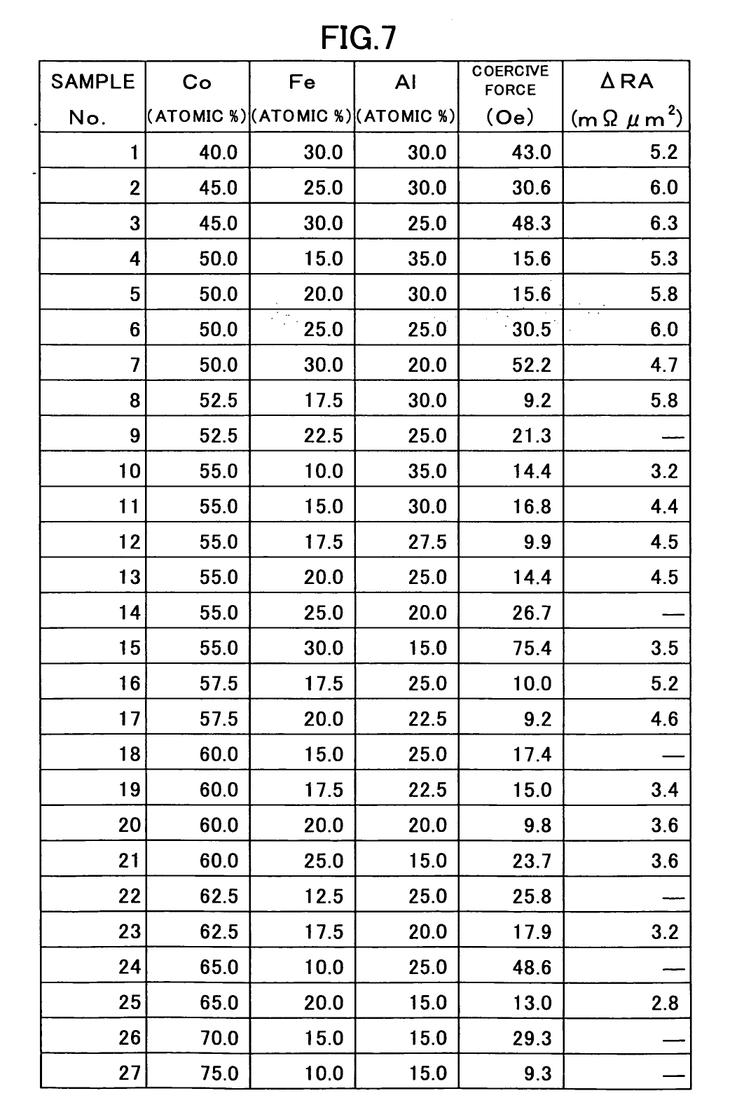

FIG. 7 is an illustration showing compositions of the free magnetization layer and the lower and upper second fixed magnetization layers, a coercive force and an amount of change in magnetic resistance ΔRA in the practical example 1.

With reference to the FIG. 7, samples of No. 1 through No. 27 are changed in their composition of CoFeAl used for the lower second fixed magnetization layer, the free magnetization layer and the upper second fixed magnetization layer. The samples of the practical example 1 were fabricated as follows.

A layered film of Cu (250 nm)/NiFe (50 nm) is formed as a lower electrode on a silicon substrate on which a thermal oxidation film is formed. Then, each layer of the foundation layer to the protection layer of the lower layered product, which has the following composition and film thickness, was formed by sputter apparatus in a ultra-vacuum atmosphere (vacuum: equal to or lower than 2×10⁻⁶ Pa) without heating the substrate. It should be noted that, in each sample, the composition of CoFeAl of the lower second fixed magnetization layer, the free magnetization layer and the upper second fixed magnetization layer is the same, and the composition is shown in FIG. 7.

Subsequently, a heat treatment was performed so as to cause an antiferromagnetism of the antiferromagnetic layer to appear. The condition of the heat treatment was set to a heating temperature of 300° C., a treatment time of 3 hours and an applied magnetic field of 1952 kA/m.

Subsequently, the thus-obtained layered product was ground by ion-milling so as to produce the layered product having six kinds of joining areas within a range from 0.1 μm² to 0.6 μm². It should be noted that 40 pieces of the layered product were fabricated for each joining area.

Subsequently, the thus-obtained layered product was covered by a silicon oxide film. Then, the protection layer was exposed by dry-etching, and an upper electrode of an Au film was formed so as to be in contact with the protection layer.

A specific structure of the GMR film of the samples No. 1 through No. 27 in the practical example 1 is shown below. It should be noted that a number in parentheses represents a film thickness, and the same applies to the practical examples mentioned below.

Foundation layer: NiCr (4 nm)

Lower antiferromagnetic Layer: IrMn (5 nm)

Lower first fixed magnetization layer: Co₆₀Fe₄₀ (3.5 nm)

Lower non-magnetic coupling layer: Ru (0.72 nm)

Lower second fixed magnetization layer: CoFeAl (5.0 nm)

Lower non-magnetic metal layer: Cu (3.5 nm)

Free magnetization layer: CoFeAl (6.5 nm)

Upper non-magnetic metal layer: Cu (3.5 nm)

Upper second fixed magnetization layer: CoFeAl (5.0 nm)

Upper magnetic coupling layer: Ru (0.72 nm)

Upper first fixed magnetization layer: Co₆₀Fe₄₀ (3.5 nm)

Upper antiferromagnetic layer: IrMn (5 nm)

Protection layer: Ru (5 nm)

An amount of change in magnetic resistance ΔR was measured for each of the thus-obtained samples No. 1 through No. 27, and an average value of amounts of change in magnetic resistance ΔR was obtained for each magnetoresistive effect element having the same level of joining area. Then, an amount of change in magnetic resistance of a unit area ΔRA was obtained from the average value of the amounts of change in magnetic resistance ΔR and the joining area A. Further, after confirming that the six kinds of magnetoresistive effect elements having different joining areas A have substantially the same ΔRA, the average value of ΔRA was set as a final ΔRA.

It should be noted that, in the measurement of the amount of change in magnetic resistance, a current value of the sense current was set to 2 mA, and an external magnetic field was swept in parallel to the direction of magnetization of the upper and lower second fixed magnetization layers in a range of −79 kA/m to 79 kA/m. A voltage between the lower electrode and the upper electrode was measured by a digital voltage meter so as to obtain a magnetic resistance curve. Then, the amount of change in magnetic resistance was obtained from a difference between a maximum value and a minimum value of the magnetic resistance curve. Additionally, the coercive force of the free magnetization layer was obtained from a hysteresis of a magnetic resistance curve that was obtained by sweeping an external magnetic field in the range of −7.9 kA/m to 7.9 kA/m in the same direction as mentioned above.

With reference to FIG. 7, it is interpreted that the amount of change in magnetic resistance ΔRA was equal to or greater than 3 mΩμm² in the samples No. 1 to No. 27. According to the study by the inventors, it was found that the amount of change in magnetic resistance ΔRA was larger than that of a case where CoFe is used for the free magnetization layer.

FIG. 8 is a ternary composition diagram of Co, Fe and Al showing a composition range of the free magnetization layer. In FIG. 8, the coercive forces (unit: Oe) of the samples No. 1 through No. 27 are indicated on the coordinates of compositions thereof.

With reference to FIG. 8, it can be appreciated that the coercive force of the free magnetization layer is decreased with respect to the coercive force Co₅₀Fe₂₅Al₂₅, which is the composition of the Heusler alloy, being 30.5 Oe on the side where Co content is larger and on the side where Fe content is smaller. On the other hand, the coercive force of the free magnetization layer is increased in a range where Co contents is 80 atomic % and Al content is 25 atomic %. From the result, it is preferable that CoFeAl of the free magnetization layer is set to a composition within a range ABCDEFA in the composition diagram of FIG. 8. The range ABCDEFA is defined by straight lines (solid thick lines in FIG. 8) connecting a point A (55, 10, 35), a point B (50, 15, 35), a point C (50, 20, 30), a point D (55, 25, 20), a point E (60, 25, 15), a point F (70, 15, 15) and the point A (55, 10, 35), where the coordinates of each composition is expressed by (Co content, Fe content, Al content). This composition range is a range where the coercive force of the free magnetization layer is equal to or smaller than 30 Oe. Accordingly, the coercive force of the free magnetization layer is smaller than that of Co₅₀Fe₂₅Al₂₅, which is the composition of the Heusler alloy, and, thereby, sensitivity to a signal magnetic field is excellent.

It should be noted that although the coercive force is equal to or smaller than 30 Oe in a range where Al content is less than 15 atomic %, ΔRA is about 1 mΩμm² and the output is reduced according to the study of the inventors. Additionally, the coercive force is smaller than 30 Oe in a range where Al content is greater than 35 atomic %. However, a saturation magnetic flux density tends to decrease in that range. Thus, in order to maintain a product of the saturation magnetic flux density and a film thickness, the film thickness of the free magnetization layer tends to increase. As a result, a read gap is increased, which reduces an output at high-density recording.

Furthermore, the composition range of CoFeAl of the free magnetization layer is preferably set to a range where the coercive force is equal to or smaller than 20 Oe. Such a composition range is a range ABCGA which is defined by straight lines (dashed thick lines in FIG. 8) connecting a point A (55, 10, 35), a point B (50, 15, 35), a point C (50, 20, 30) and a point G (65, 20, 15) and the point A (55, 10, 35) sequentially in that order. According to a composition within the range ABCGA, a sensitivity of the magnetoresistive effect element is further improved since the coercive force is smaller than that of the range ABCDEFA defined by straight lines connecting the points A, B, C, D, E, F and A in that order shown in FIG. 8.

### PRACTICAL EXAMPLE 2

In a practical example 2, the magnetoresistive effect element which has the composition of the GMR film of the fifth example according to the first embodiment shown in FIG. 6 was fabricated. In the practical example, the composition of the free magnetization layer was fixed to Co₅₀Fe₂₀Al₃₀, and the composition of CoFeAl of the lower second fixed magnetization layer and the upper second fixed magnetization layer was changed so as to form the magnetoresistive effect element of the samples No. 31 through No. 37. The composition range of the samples No. 31 through No. 37 is a range CHIDC in the diagram of FIG. 8. The range CHIDC is defined by straight lines connecting points C, H, I, D and C sequentially in that order, where the point H is (40, 30, 30) and the point I is (50, 30, 20), where the coordinates of each composite is expressed by (Co content, Fe content and Al content) in FIG. 8. It should be noted that the lower second fixed magnetization layer and the upper second fixed magnetization layer in the same sample were set to the same composition. Additionally, each of the samples No. 31 through No. 37 was fabricated in the same manner as the practical example 1, and measurement of the coercive force and ΔRA was performed in the same manner.

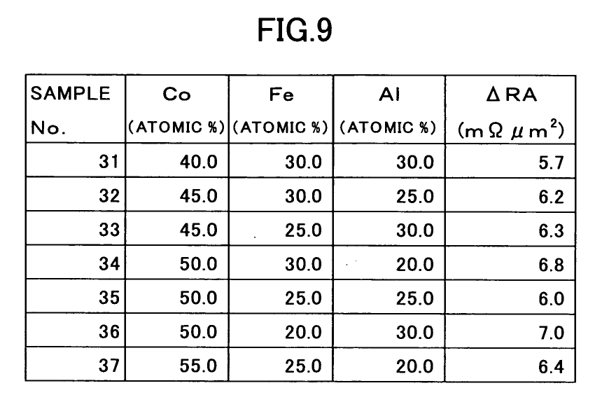

A specific structure of the GMR film of the samples No. 31 through No. 37 is shown below. It should be noted that the composition of the lower second fixed magnetization layer and the upper second fixed magnetization layer is shown in FIG. 9.

Foundation layer: NiCr (4 nm)

Lower antiferromagnetic layer: IrMn (5 nm)

Lower first fixed magnetization layer: Co₆₀Fe₄₀ (3.5 nm)

Lower non-magnetic coupling layer: Ru (0.72 nm)

First ferromagnetic joining layer: Co₄₀Fe₆₀ (0.5 nm)

Lower second fixed magnetization layer: CoFeAl (4.0 nm)

Third interface magnetic layer: Co₄₀Fe₆₀ (0.5 nm)

Lower non-magnetic metal layer: Cu (3.5 nm)

First interface magnetic layer: Co₄₀Fe₆₀ (0.25 nm)

Free magnetization layer: Co₅₀Fe₂₀Al₃₀ (6.5 nm)

Second interface magnetic layer: Co₄₀Fe₆₀ (0.25 nm)

Upper non-magnetic metal layer: Cu (3.5 nm)

Fourth interface magnetic layer: Co₄₀Fe₆₀ (0.5 nm)

Upper second fixed magnetization layer: CoFeAl (4.0 nm)

First ferromagnetic joining layer: Co₄₀Fe₆₀ (0.50 nm)

Upper magnetic coupling layer: Ru (0.72 nm)

Upper first fixed magnetization layer: Co₆₀Fe₄₀ (3.5 nm)

Upper antiferromagnetic layer: IrMn (5 nm)

Protection layer: Ru (5 nm)

The thus-obtained samples No. 31 through No. 37 showed the same coercive force, which was 11 Oe.

With reference to FIG. 9, amounts of change in magnetic resistance ΔRA of the samples No. 31-No. 37 were about 5 to 7 mΩμm², which means that relatively large ΔRA were obtained. Thus, it was found that a large amount of change in magnetic resistance ΔRA can be obtained while reducing the coercive force of the free magnetization layer by using the composition range selected in the practical example 1 (a composition within the range ABCDEFA shown in FIG. 8) and using CoFeAl of the composition range of the practical example 2 (a composition in the range CHIDC shown in FIG. 8) for the second fixed magnetization layer such as the lower second fixed magnetization layer or the upper second fixed magnetization layer. Therefore, the magnetoresistive effect element having a high output and a good sensitivity to a signal magnetic field was obtained.

### PRACTICAL EXAMPLE 3

Next, as a practical example 3, a simulation was performed about the effect which the specific resistance of the CoFeAl film gives ΔRA in the case where the CoFeAl film is used for the free magnetization layer and the second fixed magnetization layer of the magnetoresistive effect element according to the present embodiment.

As mentioned above, the CoFeAl film has a feature in that the specific resistance is very high as compared to a CoFe film conventionally used. Since the specific resistance of the CoFeAl film is high, ΔRA can be increased remarkably.

The simulation was performed by applying a so-called binary model to the CPP type magnetoresistive effect element. The binary model is based on the following two documents.

Document (1): T. Valet et al., Phys. Rev. B, vol. 48, p.p. 7099-7113 (1993)

Document (2): N. Strelkov et al., J. Appl. Phys., vol. 94, p.p. 3278-3287 (2003)

In the simulation according to the binary model, a flow path of each of electrons of up-spin and down-spin flowing in the GMR film of the magnetoresistive effect element was assumed and a specific resistance, a spin dependent bulk scattering coefficient and a film thickness of each layer constituting the GMR film were applied with respect each flow path and ΔRA was acquired. The composition of the GMR film of the simulation was the same as the GMR film 30 of the example 1 shown in FIG. 2, and the specific material and the film thickness thereof were as follows.

Foundation layer: NiCr (4 nm)

Antiferromagnetic layer: IrMn (5 nm)

First fixed magnetization layer: Co₆₀Fe₄₀ (3 nm)

Non-magnetic coupling layer: Ru (0.8 nm)

Second fixed magnetization layer: CoFeAl (5 nm)

Non-magnetic metal layer: Cu (4 nm)

Free magnetization layer: CoFeAl (5 nm)

Protection layer: Ru (4 nm)

Then, the simulation was performed by varying the specific resistance ρ and the spin-dependent bulk scattering coefficient β of the lower second fixed magnetization layer and the free magnetization layer. It should be noted that if a specific resistance is large, a spin diffusion length generally tends to be short. Thus, in the simulation, calculation was performed on the assumption that there is an inverse proportion relationship between the specific resistance ρ and the spin diffusion length and the spin diffusion length is 10 nm when the specific resistance ρ is 20 μΩcm. Additionally, for the sake of comparison, a simulation was performed for a case where a CoFe film is used for the lower second fixed magnetization layer and the free magnetization layer

### COMPARATIVE EXAMPLES 1 AND 2

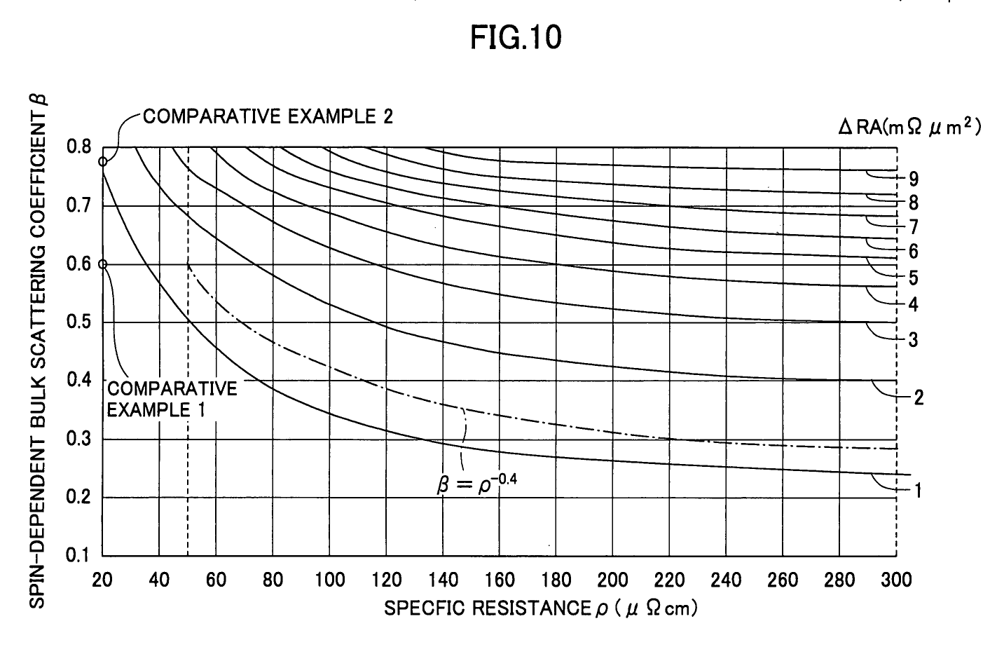

FIG. 10 is a graph showing a relationship between ΔRA and the specific resistance and the spin-dependent bulk scattering coefficient of the free magnetization layer. In FIG. 10, a vertical axis represents a spin-dependent bulk scattering coefficient β, and a horizontal axis represents a specific resistance ρ (μΩcm). Additionally, in the figure, mapping is performed according to ΔRA, and each solid line is an isopleth line of which ΔRA is equal to a constant value indicated by a figure. It should be noted that a range below the isopleth line of which ΔRA is equal to 1 indicates a range where ΔRA is smaller than 1 and equal to or greater than 0 and a range above the isopleth line of which ΔRA is equal to 9 indicates a range where ΔRA is equal to or greater than 9 and smaller than 10.

Referring to FIG. 10, in the case of the CoFe film (comparative example 1), ρ is 20 μΩcm and β is 0.6, and ΔRA is 0.5 mΩμm². Further, in the case of the CoFe film in which beta is improved (comparative example 2) as recited in the following Document (3), β was 0.77, but ΔRA was smaller than 1.2 mΩμm² according to the simulation.

Document (3): H. Yuasa et al., J. Appl. Phys., 92, p.p. 2646-2650 (2002)

On the other hand, in the case of the CoFeAl film, ρ can be various values depending on the composition (component ratio) thereof. For example, according to the simulation, when ρ of the CoFeAl film is 50 μΩcm and β is 0.6 equivalent to the CoFe film, as shown in FIG. 10, ΔRA is 1.2 mΩμm², and it can be appreciated that ΔRA is larger than the comparative example 2.

Further, when ρ of the CoFeAl film is 300 μΩcm, is 0.6 and ΔRA is 4.6 mΩμm², which is as large as 7.7 times that of the comparative example 1. It should be noted that it was found that a relationship between the specific resistance ρ and the spin-dependent bulk scattering coefficient β in which ΔRA is set to 1.2 mΩμm² is β=ρ^{-0.4} (indicated by a single-dashed chain line). β is preferably as larger as possible in the viewpoint that ΔRA is increased, and it is preferable that β is closer to 1, which is a maximum value of β.

ρ of the CoFeAl film takes various values especially depending on the aluminum content, ρ is 130 μΩcm when the aluminum content is 20 atomic %. Since β is about 0.5, ΔRA is 2.2 mΩμm², and it can be appreciated that it is extremely higher than that of the CoFe film.

Further, although ρ of the CoFeAl film can be increased by increasing the aluminum content, it is preferable that ρ is set equal to or smaller than 300 μΩcm. This is because if ρ exceeds 300 μΩcm, ΔRA tends to decrease due to reduction in a spin diffusion length or the like.

As explained above, it is preferable that ρ of the CoFeAl film is equal to or greater than 50 μΩcm and equal to or smaller than 300 μΩcm, and the spin-dependence bulk scattering coefficient beta is set as β≧ρ^{-0.4}. This range is between the dashed lines and above the single-dashed chain line in FIG. 10. By setting ρ and β of the CoFeAl film within this range, ΔRA can be larger than that of the CoFe film, and, consequently, the reproduction output of the magnetoresistive effect element can be improved.

It should be noted that although the simulation of the practical example 3 was performed on a case where the CoFeAl film was simultaneously used for the second fixed magnetization layer and the free magnetization layer, ΔRA larger than that of the CoFe film can be obtained when using the CoFeAl film for only the free magnetization layer. Additionally, β of the CoFeAl film can be obtained by, for example, a method recited in the above-mentioned Document (3).

### Second Embodiment

A magnetic head according to a second embodiment of the present invention includes a magnetoresistive effect element having a tunnel magnetoresistive effect (hereinafter, referred to as TMR) film. A structure of the magnetic head according to the second embodiment is the same as that of the magnetic head shown in FIG. 1 except for the TMR film provided instead of the GMR film 30, and a description of the magnetic head will be omitted.

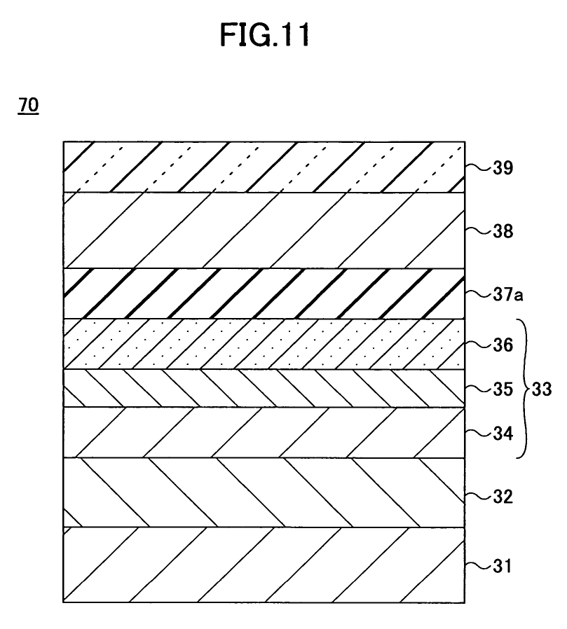

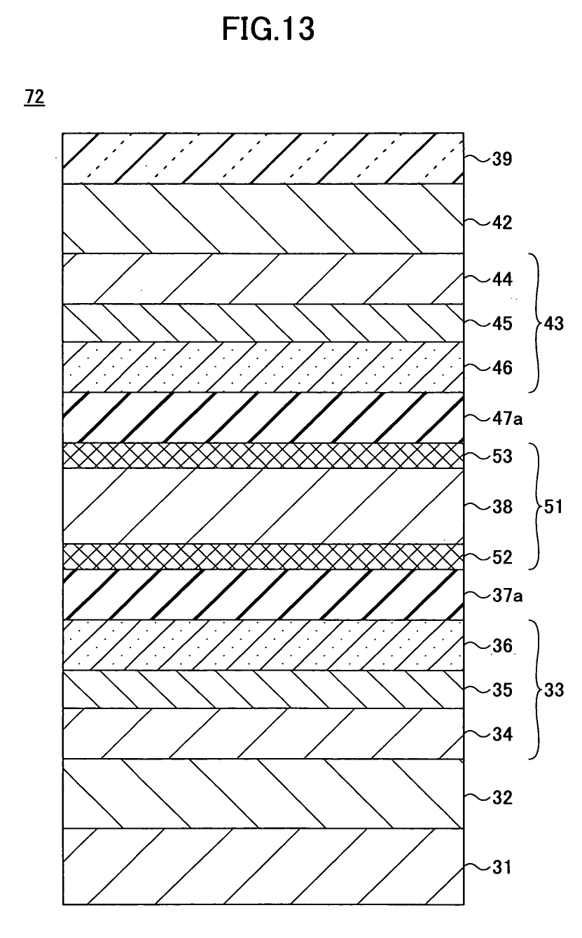

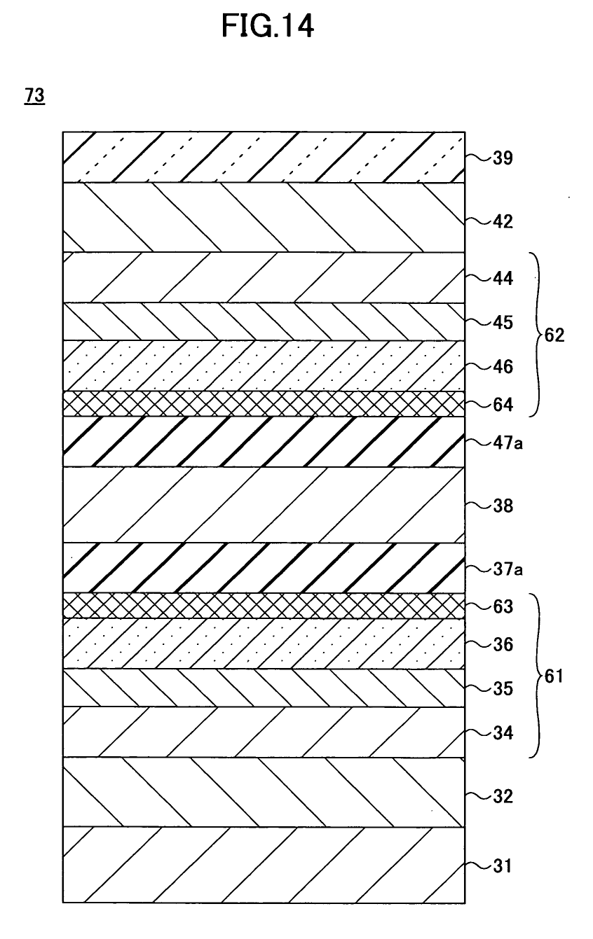

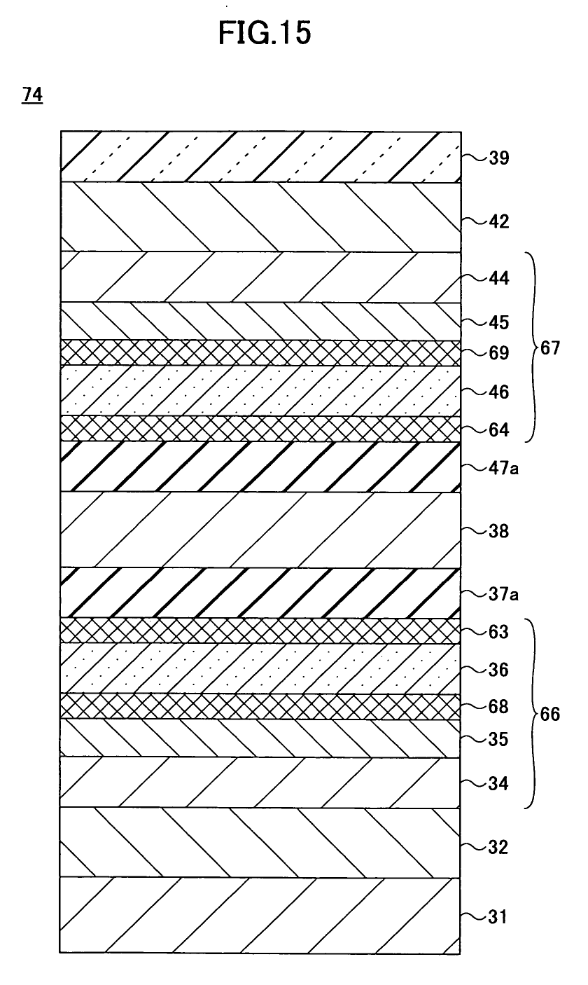

FIG. 11 through FIG. 15 are cross-sectional views of TMR films of first to fifth examples which constitute a magnetoresistive effect elements according to the second embodiment of the present invention.

With reference to FIG. 11 through FIG. 15, the TMR films 70 to 74 of the first to fifth examples has the same structures as the GMR films 30, 40, 50, 60, 65 shown in FIGS. 2 through 6 except for the non-magnetic metal layer (lower non-magnetic metal layer) 37 and the upper non-magnetic metal layer 47 being replaced by a lower non-magnetic insulating layer made of an insulating material (a non-magnetic insulation layer 37a) and an upper non-magnetic insulating layer made of an insulating material (a non-magnetic insulating layer 47a), respectively.

Each of the non-magnetic insulation films 37a and 47a has a film thickness of, for example, 0.2 nm to 2.0 nm, and is formed of an oxide of a material selected from a group consisting of Mg, Al, Ti and Zr. As such an oxide, there are MgO, AlOx, TiOx and ZrOx. Here, the suffix “x” indicates that a composition can be different from the composition of a compound of each material. Especially, it is preferable that the non-magnetic insulation films 37a and 47a are formed of crystalline MgO. Alternatively, each of the non-magnetic insulation films 37a and 47a may be formed of a nitride or a nitride compound of a material selected from a group consisting of Al, Ti and Zr. As such a nitride, there are AlN, TiN, and ZrN.

The non-magnetic insulation films 37a and 47a may be formed by a sputter method, a CVD method or a vapor deposition method which directly forms the films. Or, the non-magnetic insulation films 37a and 47a may be formed, after forming a metal film using a sputter method, a CVD method or a vapor deposition method, by changing the metal film into an oxide film or a nitride film by performing an oxidizing process or nitrizing process.

The amount of change in tunnel resistance of a unit area can be obtained in the same manner as the measurement of the amount of change in magnetic resistance of a unit area ΔRA. The amount of change in tunnel resistance of a unit area increases as the polarization of the free magnetization layer 38 and the second fixed magnetization layer 36 or 46 increases. The polarization concerned is a polarization of a ferromagnetic layer (free magnetization layer 38 and the second fixed magnetization layers 36 and 46) via an insulating layer (non-magnetic insulation films 37a and 38a). A spin-dependent bulk scattering coefficient of CoFeAl is larger than that of NiFe or CoFe that have been used conventionally. Thus, by using CoFeAl for the free magnetization layer 38, an increase in an amount of change in tunnel resistance of a unit area can be expected. Additionally, by using CoFeAl for the second fixed magnetization layers 36 and 46, an increase in an amount of change in tunnel resistance of a unit area is also expected.

The composition range of CoFeAl of the free magnetization layer 38 is set to the same composition range of CoFeAl of the free magnetization layer explained in the first embodiment (the composition range of the range ABCDEFA shown in the FIG. 8, or composition range of the range ABCGA). Thereby, the coercive force of the free magnetization layer 38 is reduced. Consequently, the magnetoresistive effect element including the TMR film having a high output and a good sensitivity to a signal magnetic field is realized.

It should be noted that although the TMR films of the third to fifth examples are variations of the TMR film of the second example in the second embodiment, a variation the same as the TMR films of the third to fifth examples may be applied to the free magnetization layer or the second fixed magnetization layer of the TMR film of FIG. 11. Additionally, the TMR film of the third example and the TMR film of the fourth or fifth example may be combined with each other.

### Third Embodiment

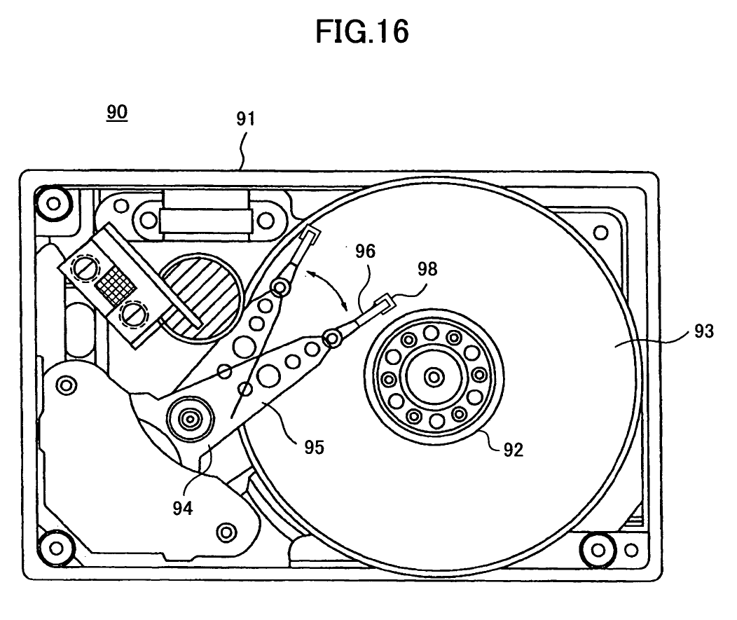

FIG. 16 is a plane view of a magnetic storage device according to a third embodiment of the present invention.

With reference to FIG. 16, a magnetic storage device 90 has a housing 91. Accommodated in the housing 91 are a hub 92 driven by a spindle (not shown in the figure), a magnetic recording medium 93 fixed to the hub 92 and rotated by the spindle, an actuator unit 94, a suspension supported by the actuator unit 94 and driven in a radial direction of the magnetic recording medium 93, and a magnetic head 98 supported by the suspension 96.

The magnetic recording medium 93 can be of an in-plane magnetic recording type or a perpendicular magnetic recording type, and may be a recording medium having oblique anisotropy. The magnetic recording medium 93 is not limited to a magnetic disc, and can be a magnetic tape.

The magnetic head 98 comprises, as shown in FIG. 1, the magnetoresistive effect element 20 and the induction type recording element 13 formed thereon. The induction type recording element 13 may be a ring type recording element for in-plane recording or a single magnetic-pole type recording element for perpendicular recording or one of other known recording elements. The magnetoresistive effect element is provided with one of the GMR films of the first to fifth examples of the first embodiment or one of the TMR films of the first to fifth examples of the second embodiment. Accordingly, the magnetoresistive effect element provides a large amount of change in magnetic resistance of a unit area or a large amount of change in tunnel resistance, which permits a high output. Thus, the magnetic storage device 90 is suitable for high-density recording. It should be noted that the basic structure of the magnetic storage device according to the present embodiment is not limited to that shown in FIG. 16.

### Fourth Embodiment

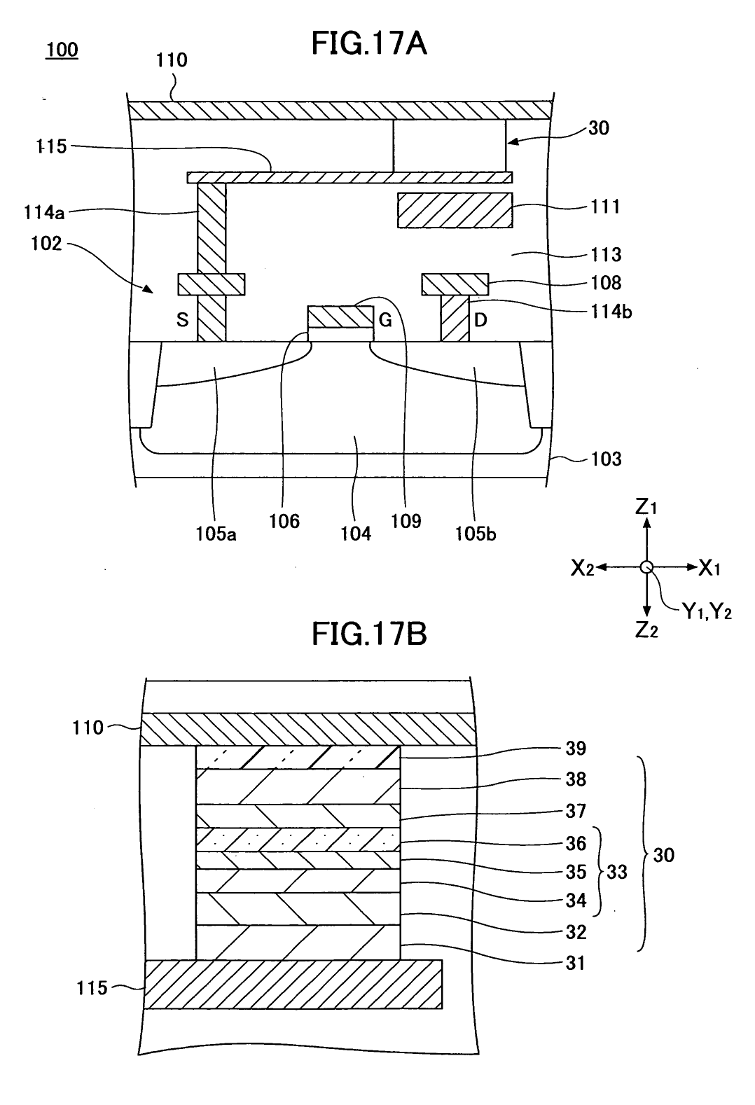

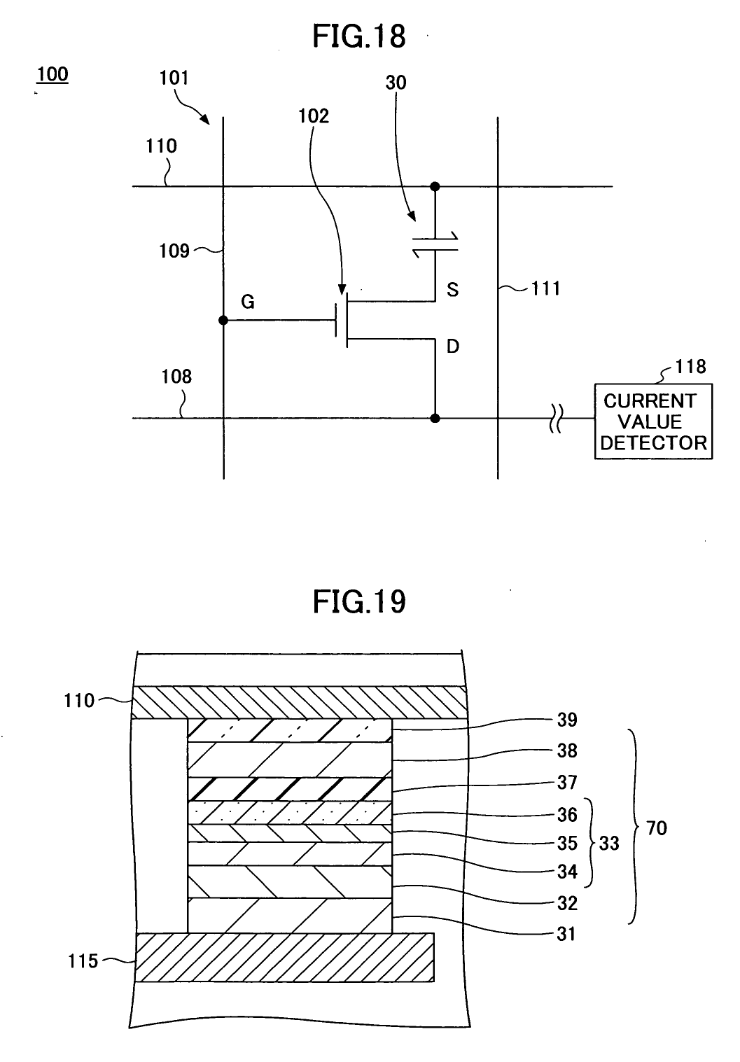

FIG. 17A is a cross-sectional view of a magnetic memory device of a first example according to a fourth embodiment of the present invention. FIG. 17B is a schematic diagram showing a configuration of the GMR film 30 shown in FIG. 17A. FIG. 18 is an equivalent circuit diagram of a memory cell of the magnetic memory device. In FIG. 17A, orthogonal coordinate axes are also shown in order to indicate directions. The Y1 and Y2 directions are perpendicular to the plane of the paper with the Y1 direction going into the plane of the paper and the Y2 direction coming out of the plane of the paper. In the following description, if a direction is merely referred to as, for example, “X direction”, the direction may be either the X1 or X2 direction. The same applies to “Y direction” and “Z direction.” In the figures, the same parts as those described above are given the same reference numerals, and descriptions thereof will be omitted.

Referring to FIGS. 17A, 17B, and 18, the magnetic memory device 100 includes a plurality of memory cells 101 arranged in a matrix manner, for example. Each memory cell 101 includes a magnetoresistive effect (GMR) film 30 and a metal-oxide-semiconductor field effect transistor (MOSFET) 102. A p-channel MOSFET or an n-channel MOSFET may be used for the MOSFET 102. Here, a description is given taking an n-channel MOSFET, in which electrons serve as carriers, as an example.

The MOSFET 102 has a p-well region 104 containing a p-type impurity formed in a silicon substrate 103, and impurity diffusion regions 105a and 105b formed, separate from each other, in the vicinity of the surface of the silicon substrate 103 in the p-well region 104, n-type impurity being introduced into the impurity diffusion regions 105a and 105b. Here, the impurity diffusion region 105a serves as a source S, and the other impurity diffusion region 105b serves as a drain D. The MOSFET 102 has a gate electrode G formed on a gate insulating film 106 on the surface of the silicon substrate 103 between the two impurity diffusion regions 105a and 105b.

The source S of the MOSFET 102 is electrically connected to one side of the GMR film 30, for example, the foundation layer 31, through a vertical wiring 114a and an in-layer wiring 115. Further, a plate line 108 is electrically connected to the drain D through a vertical wiring 114b. A word line 109 for reading is electrically connected to the gate electrode G. Alternatively, the gate electrode G may also serve as the word line 109 for reading.

Further, a bit line 110 is electrically connected to the other side of the GMR film 30, for example, the protection film 39. A word line 111 for writing is provided below the GMR film 30 in isolation therefrom.

The GMR film 30 has the same configuration as shown in FIG. 2. In the GMR film 30, the easy magnetization axis and the hard magnetization axis of the free magnetization layer 38 are oriented along the X-axis and Y-axis, respectively, shown in FIG. 17A. The directions of the easy magnetization axis may be formed either by heat treatment or according to shape anisotropy. In the case of forming the easy magnetization axis in the X-axial directions according to shape anisotropy, the shape of a cross section of the GMR film 30 parallel to its film surface (or parallel to the X-Y plane) is caused to be a rectangle having a longer side in the X direction than a side in the Y direction.

In the magnetic memory device 100, the surface of the silicon substrate 103 and the gate electrode G are covered with an interlayer insulating film 113 such as a silicon nitride film or a silicon oxide film. The GMR film 30, the plate line 108, the word line 109 for reading, the bit line 110, the word line 111 for writing, the vertical wirings 114a and 114b, and the in-layer wiring 115 have the above-described electrical connections, but otherwise they are electrically isolated from each other by the interlayer insulating film 113.

The magnetic memory device 100 retains information in the GMR film 30. Information is retained based on whether the direction of magnetization of the free magnetization layer 38 is parallel to or antiparallel to the direction of magnetization of the second fixed magnetization layer 36.

Next, a description will be given of a write operation and a read operation of the magnetic memory device 100. The operation of the magnetic memory device 100 to write information into the GMR film 30 is performed by the bit line 110 and the word line 111 for writing disposed above and below the GMR film 30, respectively. The bit line 110 extends in the X direction on the GMR film 30. By causing current to flow through the bit line 110, a magnetic field is applied to the GMR film 30 in the Y direction. The word line 111 for writing extends in the Y direction below the GMR film 30. By causing current to flow through the word line 111 for writing, a magnetic field is applied to the GMR film 30 in the X direction.

The magnetization of the free magnetization layer 38 of the GMR film 30 is oriented in the X direction (for example, the X2 direction) when substantially no magnetic field is applied. The direction of the magnetization is stable.

When writing information into the GMR film 30, a current is caused to flow through the bit line 110 and the word line 111 for writing at the same time. For example, in the case of orienting the magnetization of the free magnetization layer 38 in the X1 direction, the current is caused to flow through the word line 111 for writing in the Y1 direction. As a result, the magnetic field is oriented in the X1 direction in the GMR film 30. At this point, the direction of the current caused to flow through the bit line 110 may be either the X1 direction or the X2 direction. The magnetic field generated by the current flowing through the bit line 110 is in the Y1 direction or the Y2 direction in the GMR film 30, and functions as a part of the magnetic field for the magnetization of the free magnetization layer 38 to cross the barrier of the hard magnetization axis. That is, as a result of simultaneous application of the magnetic field in the X1 direction and the magnetic field in the Y1 or Y2 direction to the magnetization of the free magnetization layer 38, the magnetization of the free magnetization layer 38 oriented in the X2 direction is reversed to be in the X1 direction. After the magnetic fields are removed, the magnetization of the free magnetization layer 38 remains oriented in the X1 direction, and is stable unless a magnetic field of a next write operation or a magnetic field for erasure are applied.

Thus, “1” or “0” can be recorded in the GMR film 30 depending on the direction of the magnetization of the free magnetization layer 38. For example, when the direction of magnetization of the second fixed magnetization layer 36 is the X1 direction, “1” is recorded if the direction of magnetization of the free magnetization layer 38 is the X1 direction (the state of low tunnel resistance) and “0” is recorded if the direction of magnetization of the free magnetization layer 38 is the X2 direction (the state of high tunnel resistance).

The magnitude of each of the currents supplied to the bit line 110 and the word line 111 for writing at the time of the write operation is such that a flow of current through one of the bit line 110 and the word line 111 alone does not reverse the magnetization of the free magnetization layer 38. As a result, recording is performed only in the magnetization of the free magnetization layer 38 of the GMR film 30 at the intersection of the bit line 110 supplied with current and the word line 111 for writing supplied with current. The source S side is set at high impedance so as to prevent a current from flowing through the GMR film 30 at the time of causing current to flow through the bit line 110 in the write operation.

Meanwhile, the operation of the magnetic memory device 100 to read out information from the GMR film 30 is performed by applying to the bit line 110 a negative voltage relative to the source S and applying a voltage higher than the threshold voltage of the MOSFET 102 (a positive voltage) to the word line 109 for reading, that is, the gate electrode G. As a result, the MOSFET 102 turns ON so that electrons flow from the bit line 110 to the plate line 108 through the GMR film 30, the source S, and the drain D. By electrically connecting a current value detector 118 such as an ammeter to the plate line 108, a magnetoresistance value corresponding to the direction of magnetization of the free magnetization layer 38 relative to the direction of magnetization of the second fixed magnetization layer 36 is detected. Thereby, it is possible to read out the information of “1” or “0” retained by the GMR film 30.

According to the magnetic memory device 100 of the first example according to the fourth embodiment of the present invention, the free magnetization layer 38 of the GMR film 30 is formed of CoFeAl, so that the an amount of change ΔRA in the magnetoresistance is large. Therefore, according to the magnetic memory device 100, there is a large difference between the magnetoresistance values corresponding to retained “0” and “1” respectively, at the time of reading out information, so that it is possible to perform reading with accuracy. Further, in the GMR film 30, the coercive force of the free magnetization layer 38 is smaller than that of Co₅₀Fe₂₅Al₂₅, which is a Heusler alloy composition, since CoFeAl of the free magnetization layer 38 is set to a composition within the range ABCDEFA shown in FIG. 8. Therefore, according to the magnetic memory unit 100, it is possible to reduce an applied magnetic field in the write operation, so that it is possible to reduce current caused to flow through the bit line 110 and the word line 111 for writing in the write operation. Therefore, according to the magnetic memory device 100, it is possible to reduce power consumption.

It should be noted that the GMR film 30 constituting the magnetic memory device 100 may be replaced by any one of the GMR films 40, 50, 60 and 65 of the second through fifth examples shown in FIG. 3 through FIG. 6.

FIG. 19 is a diagram showing a configuration of the TMR film forming a variation of the magnetic memory device 100 of the first example. Referring to FIG. 19 together with FIG. 17A, the GMR film 30 of the magnetic memory device 100 may also be replaced by the TMR film 70. The TMR film 70 has the same configuration as the TMR film of the first example forming the magnetoresistive effect element according to the second embodiment. According to the TMR film 70, for example, the foundation layer 31 is in contact with the in-layer wiring 115, and the protection film 39 is in contact with the bit line 110. Further, the easy magnetization axis of the free magnetization layer 38 is disposed in the same manner as in the above-described GMR film 30. The write operation and the read operation of the magnetic memory device 110 in the case of employing the TMR film 70 are the same as in the case of employing the GMR film 30, and, thus, descriptions thereof will be omitted.

As described in the second embodiment, the TMR film 70 exhibits a tunnel effect. In the TMR film 70, an amount of change in the tunnel resistance is large since the free magnetization layer 38 is formed of CoFeAl. Therefore, according to the magnetic memory device 100, there is a large difference between the tunnel resistance values corresponding to retained “0” and “1” at the time of reading out information, so that it is possible to perform reading with accuracy. Further, since the coercive force of the free magnetization layer 38 is reduced, the sensitivity of the TMR film 70 is high. Therefore, according to the magnetic memory device 100, it is possible to reduce power consumption.

It should be noted that any of the TMR films of the second through fourth examples may be used for the TMR film constituting the magnetic memory device.

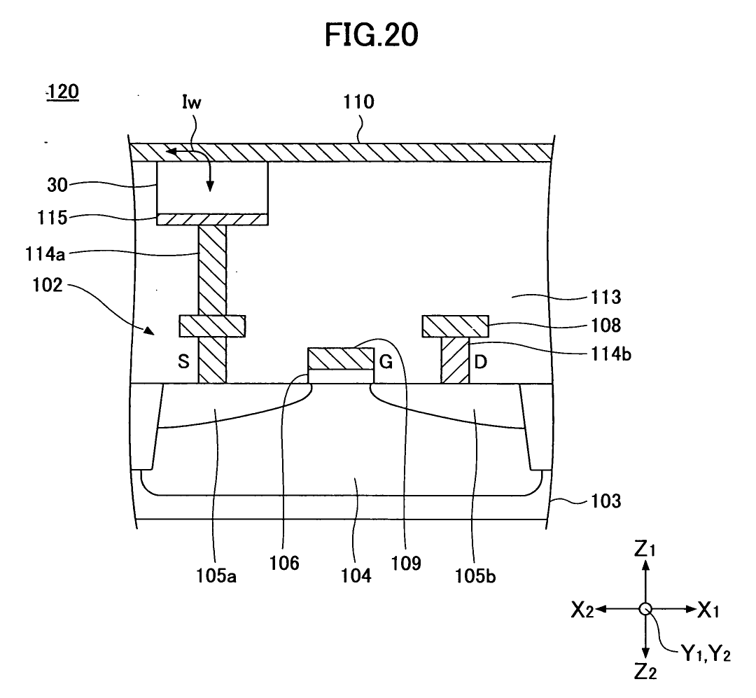

FIG. 20 is a cross-sectional view of a magnetic memory device of a second example according to the fourth embodiment of the present invention. In FIG. 20, parts that correspond to the parts explained above are given the same reference numerals, and descriptions thereof will be omitted.

Referring to FIG. 20, the magnetic memory unit 120 has a mechanism for writing information into the GMR film 30 different from that of the magnetic memory device 100 of the first example. Each memory cell of the magnetic memory device 120 has the same configuration as the memory cell 101 shown in FIGS. 17A and 17B except that the word line 111 for writing is not provided. A description will be given below of the magnetic memory device 120 with reference to FIG. 20 together with FIG. 17B.

The write operation of the magnetic memory device 120 is different from that of the magnetic memory device 100 of the first example. According to the magnetic memory device 120, a polarization spin current Iw is injected into the GMR film 30, and the direction of magnetization of the free magnetization layer 38 is reversed, depending on the direction of the injected current Iw, from the parallel state to the antiparallel state or from the antiparallel state to the parallel state relative to the direction of magnetization of the second fixed magnetization layer 36. The polarization spin current Iw is a flow of electrons of one of the two spin directions that the electrons can take. By causing the polarization spin current Iw to flow through the GMR film 30 in the Z₁ direction or the Z₂ direction, a torque is generated in the magnetization of the free magnetization layer 38 so as to cause so-called spin transfer magnetization switching (reversal). The amount of current of the polarization spin current Iw, which is suitably selected in accordance with the film thickness of the free magnetization layer 38, is approximately a few mA to 20 mA. The polarization spin current Iw is smaller in amount than the current caused to flow through the bit line 110 and the word line 111 for writing in the write operation of the magnetic memory device of the first example shown in FIG. 17A. Therefore, according to the magnetic memory device 120, it is possible to further reduce power consumption.

It is possible to generate a polarization spin current by causing a current to flow perpendicularly through a multilayer body having substantially the same configuration as the GMR film 30 with two ferromagnetic layers and a Cu film sandwiched therebetween. The spin direction of electrons can be controlled by causing the directions of magnetization of the two ferromagnetic layers to be parallel or antiparallel to each other. The read operation of the magnetic memory device 120 is the same as that of the magnetic memory device 100 of the first example shown in FIG. 17A.

The magnetic memory device 120 of the second example provides the same effects as the magnetic memory device 100 of the first example. Further, according to the magnetic memory device 120 of the second example, it is possible to further reduce power consumption.

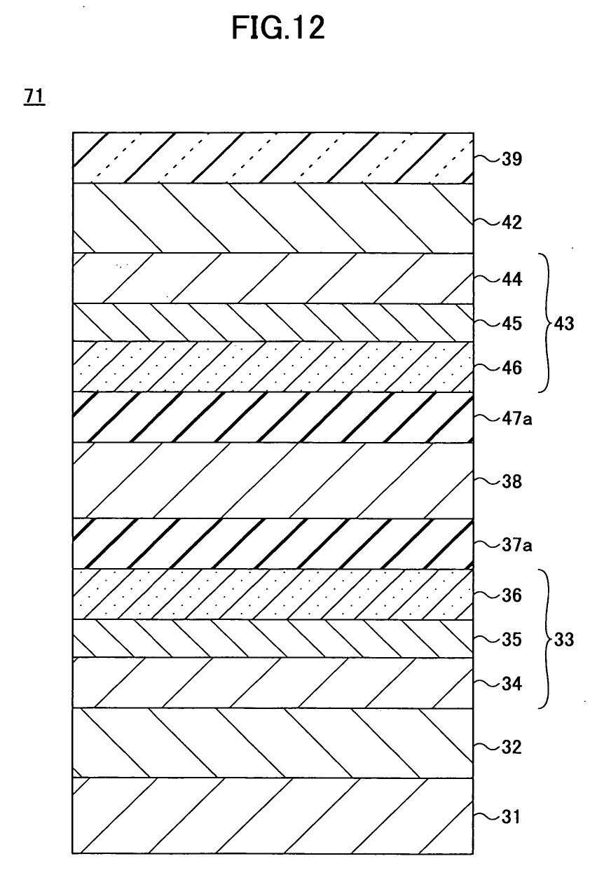

It should be noted that the GMR film 30 of the magnetic memory device 120 may be replaced by any one of the GMR films 40, 50, 60 and 65 of the second through fifth examples of shown in FIG. 3 through FIG. 6, or may be replaced by one of the TMR films of the first through fourth examples shown in FIG. 12 through FIG. 15.

Additionally, although, in the magnetic memory devices of the first example and the second example of the fourth embodiment, a direction of a current is controlled by the MOSFET when performing a write operation and a read operation, such a control may be performed by any other known methods.

Although the description has been given of the case where the magnetic recording medium is a disk shape recording medium in the third embodiment, the present invention can be applied to a magnetic tape drive using a magnetic tape as a recording medium. Additionally, the description has been given of the magnetic head having the magnetoresistive effect element and the recording element, the present invention is applicable to a magnetic head having only a magnetoresistive effect element or a magnetic head having a plurality of magnetoresistive effect elements.

Although the description have been given of the preferred embodiments, the present invention is not limited to the specifically disclosed embodiments, and variations and modifications may be made without departing from the scope of the present invention.

The present application is based on Japanese priority applications No. 2005-244507 filed Aug. 25, 2005 and No. 2006-087433 filed Mar. 28, 2006, the entire contents of which are hereby incorporated herein by reference.

What is claimed is:

1. A magnetoresistive effect element of a CPP type, comprising:
a fixed magnetization layer;
a non-magnetic layer; and
a free magnetization layer formed of CoFeAl,
wherein the CoFeAl has a composition falling within a range defined by straight lines connecting points A, B, C, D, E, F and A, in that order, in a ternary composition diagram where the point A is (55, 10, 35), the point B is (50, 15, 35), the point C is (50, 20, 30), the point D is (55, 25, 20), the point E is (60, 25, 15), and the point F is (70, 15, 15), where coordinates of the composition of each point is represented by (Co content, Fe content, Al content), where each content is expressed by atomic percent.

2. A magnetoresistive effect element as claimed in claim 1, further comprising a second non-magnetic layer and another fixed magnetic layer, wherein the fixed magnetization layer, the non-magnetic layer, the free magnetization layer, the second non-magnetic layer and the another fixed layer are stacked in that order.

3. The magnetoresistive effect element as claimed in claim 1, wherein the CoFeAl has a composition falling in a range defined by straight lines connecting points A, B, C, G and A, in that order, in a ternary composition diagram where the point A is (55, 10, 35), the point B is (50, 15, 35), the point C is (50, 20, 30), and the point G is (65, 20, 15), where coordinates of each composition is represented by (Co content, Fe content, Al content), where each content is expressed by atomic percent.

4. The magnetoresistive effect element as claimed in claim 1, wherein said fixed magnetization layer is formed of CoFeAl.

5. The magnetoresistive effect element as claimed in claim 4, wherein the CoFeAl of said fixed magnetization layer has a composition falling within a range defined by straight lines connecting points C, H, I, D and C, in that order, in a ternary composition diagram where the point C is (50, 20, 30), the point H is (40, 30, 30), the point I is (50, 30, 20) and the point D is (55, 25, 20), where coordinates of each composition is represented by (Co content, Fe content, Al content), where each content is expressed by atomic percent.

6. The magnetoresistive effect element as claimed in claim 2, wherein said another fixed magnetization layer is formed of CoFeAl.

7. The magnetoresistive effect element as claimed in claim 6, wherein the CoFeAl of said another fixed magnetization layer has a composition falling within a range defined by straight lines connecting points C, H, I, D and C, in that order, in a ternary composition diagram where the point C is (50, 20, 30), the point H is (40, 30, 30), the point I is (50, 30, 20) and the point D is (55, 25, 20), where coordinates of each composition is represented by (Co content, Fe content, Al content), where each content is expressed by atomic percent.

8. The magnetoresistive effect element as claimed in claim 1, wherein said fixed magnetization layer includes a first fixed magnetization layer, a non-magnetic coupling layer and a second fixed magnetization layer stacked in that order so that said second fixed layer is in contact with said nonmagnetic layer, and wherein said second fixed magnetization layer is formed of CoFeAl.

9. The magnetoresistive effect element as claimed in claim 8, wherein the CoFeAl of said second fixed magnetization layer has a composition falling within a range defined by straight lines connecting points C, H, I, D and C, in that order, in a ternary composition diagram where the point C is (50, 20, 30), the point H is (40, 30, 30), the point I is (50, 30, 20) and the point D is (55, 25, 20), where coordinates of each composition is represented by (Co content, Fe content, Al content), where each content is expressed by atomic percent.

10. The magnetoresistive effect element as claimed in claim 2, wherein each of said fixed magnetization layer and said another fixed magnetization layer includes a first fixed magnetization layer, a non-magnetic coupling layer and a second fixed magnetization layer stacked in that order, and wherein said second fixed magnetization layer is formed of CoFeAl.

11. The magnetoresistive effect element as claimed in claim 10, wherein the CoFeAl of said second fixed magnetization layer has a composition falling within a range defined by straight lines connecting points C, H, I, D and C, in that order, in a ternary composition diagram where the point C is (50, 20, 30), the point H is (40, 30, 30), the point I is (50, 30, 20) and the point D is (55, 25, 20), where coordinates of each composition is represented by (Co content, Fe content, Al content), where each content is expressed by atomic percent.

12. The magnetoresistive effect element as claimed in claim 1, further comprising an interface magnetic layer formed of a ferromagnetic material on at least one side of said free magnetization layer.

13. The magnetoresistive effect element as claimed in claim 1, wherein said non-magnetic layer is formed of an electrically conductive material.

14. The magnetoresistive effect element as claimed in claim 1, wherein said non-magnetic layer is formed of an insulating material.

15. The magnetoresistive effect element as claimed in claim 1, wherein the CoFeAl has a specific resistance ρ equal to or greater than 50 μΩcm and equal to or smaller than 300 μΩcm and a spin-dependent bulk scattering coefficient β is set to satisfy a relationship β≧ρ^{-0.4}.

16. A magnetic head comprising:
a substrate forming a base of a head slider; and
the magnetoresistive effect element as claimed in claim 1 formed on said substrate.

17. A magnetic storage device comprising:
a magnetic recording medium; and
a magnetic head reading information recorded on the magnetic recording medium, the magnetic head including the magnetoresistive effect element as claimed in claim 1.

18. A magnetic memory device comprising:
a magnetoresistive effect film of a CPP type having a fixed magnetization layer, a non-magnetic layer, and a free magnetization layer;
writing means for orienting a magnetization of said free magnetization layer to a predetermined direction by applying a magnetic field to said magnetoresistive effect film; and
reading means for detecting a resistance value by supplying a sense current to said magnetoresistive effect film,
wherein said free magnetization layer is made of CoFeAl, and the CoFeAl has a composition falling within a range defined by straight lines connecting points A, B, C, D, E, F and A, in that order, in a ternary composition diagram where the point A is (55, 10, 35), the point B is (50, 15, 35), the point C is (50, 20, 30), the point D is (55, 25, 20), the point E is (60, 25, 15), and the point F is (70, 15, 15), where coordinates of the composition of each point is represented by (Co content, Fe content, Al content), where each content is expressed by atomic percent.

19. A magnetic memory device as claimed in claim 18, further comprising a second non-magnetic layer and another fixed magnetic layer, wherein the fixed magnetization layer, the non-magnetic layer, the free magnetization layer, the second non-magnetic layer and the another fixed layer are stacked in that order.

20. The magnetic memory device as claimed in claim 18, wherein said writing means applies a first magnetic field parallel to a film surface of the magnetoresistive effect film and in one of directions of easy magnetization axes of said free magnetic layer, and also applied a second magnetic field substantially parallel to the film surface and in a direction at a predetermined angle to the first magnetic field so as to control the direction of magnetization of said free magnetization layer.

21. The magnetic memory device as claimed in claim 20, further comprising a bit line, a word line and a MOS transistor having a control electrode and two current supply electrodes,
wherein said word line is electrically connected to the control electrode;
said magnetoresistive effect film is electrically connected between said bit line and one of said current supply electrodes; and
said reading means turns on said MOS transistor by setting a predetermined voltage to said word line to cause a sense current to flow between said bit line and said one of the current supply electrodes so as to detect a magnetic resistance value.

22. The magnetic memory device as claimed in claim 18, wherein said writing means controls a direction of magnetization of said free magnetization layer by introducing electron flow having a polarized spin into said magnetoresistive effect film.

23. The magnetic memory device as claimed in claim 22, further comprising a bit line, a word line and a MOS transistor having a control electrode and two current supply electrodes,
wherein said word line is electrically connected to the control electrode;
said magnetoresistive effect film is electrically connected between said bit line and one of said current supply electrodes;
said reading means turns on said MOS transistor by setting a predetermined voltage to said word line to cause a sense current to flow between said bit line and said one of the current supply electrodes so as to detect a magnetic resistance value.
